(19) United States
(12) Patent Application Publication
(10) Pub. No.: US 2026/0128548 A1
(43) Pub. Date: May 7, 2026

(54) LOOP BACK CONNECTORS AND BACKPLANE SYSTEMS

(71) Applicant: Molex, LLC, Lisle, IL (US)

(72) Inventors: Alan Crighton, Austin, TX (US); Marx G. Succes, JR., Lisle, IL (US)

(21) Appl. No.: 19/353,737

(22) Filed: Oct. 9, 2025

Related U.S. Application Data
(60) Provisional application No. 63/714,880, filed on Nov. 1, 2024.

(51) Int. Cl. H01R 13/518; H01R 12/72; H01R 13/187; H01R 13/504; H01R 13/66

(52) U.S. Cl. CPC H01R 13/518; H01R 12/727; H01R 13/187; H01R 13/504; H01R 13/6658

(57) ABSTRACT

Loop back connectors and storage backplane systems are described. An example connector includes a connector housing, a row of terminal conductors positioned within the connector housing, and a circuit board including a main connector tab positioned within the connector housing and a loop back connector tab that extends outside of the connector housing. The connector can also include a data cable with conductors coupled to contact pads on the circuit board in one example. In another example, the connector can include a data cable with conductors directly coupled to terminal conductors among the row of terminal conductors. An example storage system includes a backplane circuit board, a support shroud positioned over an aperture through the backplane circuit board, a card edge connector adjacent to the support shroud, and a loop back connector positioned within the support shroud with a loop back connector tab mated with the card edge connector.

### BACKGROUND

A range of input/output (I/O) connectors are designed for power, data, and power and data interconnect systems, including board-to-board, wire-to-wire, and wire-to-board systems. A variety of designs exist for each type of system, depending on the requirements of the power and data communications environment in which the connectors are used. As one example, a wire-to-board system includes a free-end connector attached to a wire and a fixed-end connector attached to a board.

It can be challenging to design interconnection system connectors, particularly for high data rate applications, due to a number of competing concerns. High data rate interconnection systems often rely upon differentially coupled conductor pairs to transmit a differential signal. The signal being transmitted is embodied by the electrical difference measured between the conductor pair. Differential signaling can be helpful to avoid spurious signals and crosstalk and avoid inadvertent signaling modes among adjacent signal pairs. In connector interfaces, ground or drain terminals can be relied upon to create a return path to electrical ground, provide shielding between differential pairs, and for other purposes.

Connectors used in high data rate applications are typically designed to meet a range of mechanical and electrical requirements. High data rate connectors are often used in backplane applications, as one example, that require very high conductor density and data rates. To achieve the desired mechanical and electrical requirements, the connectors used in such applications often incorporate one or more wafer assemblies, among other components. It is still challenging, in any case, to design connectors having the conductor density and size needed for high data rate applications in new systems, while also maintaining the desired electrical characteristics for the transmission of data with integrity.

### SUMMARY

Loop back connectors and storage backplane systems are described. An example connector includes a connector housing, a row of terminal conductors positioned within the connector housing, and a circuit board including a main connector tab positioned within the connector housing and a loop back connector tab that extends outside of the connector housing. The connector can also include a data cable with conductors coupled to contact pads on the circuit board in one example. In another example, the connector can include a data cable with conductors directly coupled to terminal conductors among the row of terminal conductors. An example storage system includes a backplane circuit board, a support shroud positioned over an aperture through the backplane circuit board, a card edge connector adjacent to the support shroud, and a loop back connector positioned within the support shroud with a loop back connector tab mated with the card edge connector.

In some aspects, the circuit board includes loop back contact pads and bypass contact pads coupled to corresponding loop back terminal conductors and bypass terminal conductors in the row of terminal conductors. The loop back contact pads are electrically coupled to corresponding loop back contact pads positioned on the card edge connector tab. The bypass contact pads are electrically coupled to corresponding bypass contact pads positioned on the circuit board. In some cases, the connector also includes a data cable coupled to the row of terminal conductors. The data cable is coupled to the corresponding bypass contact pads on the circuit board and coupled to the row of terminal conductors by way of the circuit board in some examples. In other cases, the data cable is directly coupled to terminal conductors in the row of terminal conductors.

In another example, a storage system includes a backplane circuit board having a connector aperture formed through the backplane circuit board from a first side to a second side of the backplane circuit board. The storage system further includes a support shroud and a card edge connector that are each coupled to the backplane circuit board. The support shroud includes a support frame that is aligned with the connector aperture. The card edge connector is coupled to the backplane circuit board at a location adjacent to the support frame. In some examples, the connector is positioned within the support frame with the connector housing extending through the connector aperture and past the second side of the backplane circuit board. The card edge connector tab of the connector is positioned outside of the connector, outside of the support frame, and within the card edge connector in these examples.

The loop back terminal conductors in the connector housing, the loop back contact pads on the circuit board, and the card edge connector coupled to the backplane circuit board can be used together in one example to communicate at least one of relatively low-speed differential data signals, power signals, sideband signals, or other signals. For instance, the loop back terminal conductors, the loop back contact pads, and the card edge connector can be used together to communicate such signals between the backplane circuit board and an external device that can be coupled to the loop back terminal conductors when the connector is positioned within the support frame.

The bypass terminal conductors in the connector housing, the bypass contact pads on the circuit board, and the data cable can be used together in one example to communicate relatively high-speed differential data signals. Such signals can bypass the backplane circuit board. For instance, the bypass terminal conductors, the bypass contact pads, and the data cable can be used together to communicate such signals directly between one external device coupled to a free-end of the data cable and another external device coupled to the bypass terminal conductors when the connector is positioned within the support frame.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1A illustrates a perspective view of an example connector according to various embodiments of the present disclosure.

FIG. 1B illustrates a top view of the connector shown in FIG. 1A according to various embodiments of the present disclosure.

FIG. 1C illustrates a bottom view of the connector shown in FIG. 1A according to various embodiments of the present disclosure.

FIG. 1D illustrates a front view of the connector shown in FIG. 1A according to various embodiments of the present disclosure.

FIG. 1E illustrates a side view of the connector shown in FIG. 1A according to various embodiments of the present disclosure.

FIG. 2A illustrates the perspective view of the connector shown in FIG. 1A with an overmold housing omitted from view according to various embodiments of the present disclosure.

FIG. 2B illustrates the top view of the connector shown in FIG. 2A according to various embodiments of the present disclosure.

FIG. 2C illustrates the bottom view of the connector shown in FIG. 2A according to various embodiments of the present disclosure.

FIG. 2D illustrates a back view of the connector shown in FIG. 2A according to various embodiments of the present disclosure.

FIG. 2E illustrates the side view of the connector shown in FIG. 2A according to various embodiments of the present disclosure.

FIG. 3A illustrates a perspective view of a connector housing and row of terminal conductors of the connector shown in FIG. 1A according to various embodiments of the present disclosure.

FIG. 3B illustrates a top view of the connector housing and terminal conductors shown in FIG. 3A according to various embodiments of the present disclosure.

FIG. 3C illustrates a bottom view of the connector housing and terminal conductors shown in FIG. 3A according to various embodiments of the present disclosure.

FIG. 3D illustrates the cross-sectional view of the connector housing and terminal conductors designated A-A in FIG. 1D according to various embodiments of the present disclosure.

FIG. 3E illustrates the cross-sectional view of the connector housing designated B-B in FIG. 3D according to various embodiments of the present disclosure.

FIG. 3F illustrates a cross-sectional view of the connector housing designated C-C in FIG. 3D according to various embodiments of the present disclosure.

FIG. 3G illustrates a perspective view of the connector housing shown in FIG. 3A with wafer assemblies omitted from view according to various embodiments of the present disclosure.

FIG. 3H illustrates another perspective view of the connector housing shown in FIG. 3A with the wafer assemblies omitted from view according to various embodiments of the present disclosure.

FIG. 4A illustrates a perspective view of a circuit board of the connector shown in FIG. 1A according to various embodiments of the present disclosure.

FIG. 4B illustrates a top view of the circuit board shown in FIG. 4A according to various embodiments of the present disclosure.

FIG. 4C illustrates a bottom view of the circuit board shown in FIG. 4A according to various embodiments of the present disclosure.

FIG. 5A illustrates a perspective view of another example connector housing, terminal conductors, and data cables of the connector shown in FIG. 1A according to various embodiments of the present disclosure.

FIG. 5B illustrates a top view of the connector housing, terminal conductors, and data cables shown in FIG. 5A according to various embodiments of the present disclosure.

FIG. 6A illustrates a perspective view of an example loop back connector storage backplane system according to various embodiments of the present disclosure.

FIG. 6B illustrates an exploded perspective view of the loop back connector storage backplane system shown in FIG. 6A with a connector omitted from view according to various embodiments of the present disclosure.

FIG. 6C illustrates a top view of a storage loop back unit of the loop back connector storage backplane system shown in FIG. 6A according to various embodiments of the present disclosure.

FIG. 6D illustrates the top view of the storage loop back unit shown in FIG. 6C with the connector omitted from view according to various embodiments of the present disclosure.

FIG. 6E illustrates a front view of the storage loop back unit shown in FIG. 6C according to various embodiments of the present disclosure.

FIG. 6F illustrates the front view of the storage loop back unit shown in FIG. 6E with the connector omitted from view according to various embodiments of the present disclosure.

FIG. 6G illustrates the top view of the storage loop back unit shown in FIG. 6D with a backplane circuit board omitted from view according to various embodiments of the present disclosure.

FIG. 6H illustrates a back view of the storage loop back unit shown in FIG. 6C with the backplane circuit board omitted from view according to various embodiments of the present disclosure.

FIG. 7A illustrates a perspective view of another example loop back connector storage backplane system according to various embodiments of the present disclosure.

FIG. 7B illustrates an exploded perspective view of the loop back connector storage backplane system shown in FIG. 7A with a connector omitted from view according to various embodiments of the present disclosure.

FIG. 7C illustrates a top view of a storage loop back unit of the loop back connector storage backplane system shown in FIG. 7A according to various embodiments of the present disclosure.

FIG. 7D illustrates the top view of the storage loop back unit shown in FIG. 7C with the connector omitted from view according to various embodiments of the present disclosure.

FIG. 7E illustrates a front view of the storage loop back unit shown in FIG. 7C according to various embodiments of the present disclosure.

FIG. 7F illustrates the front view of the storage loop back unit shown in FIG. 7E with the connector omitted from view according to various embodiments of the present disclosure.

FIG. 7G illustrates the top view of the storage loop back unit shown in FIG. 7D with a backplane circuit board omitted from view according to various embodiments of the present disclosure.

FIG. 7H illustrates a back view of the storage loop back unit shown in FIG. 7C with the backplane circuit board omitted from view according to various embodiments of the present disclosure.

### DETAILED DESCRIPTION

A range of different connectors are designed to meet the mechanical and electrical requirements for different applications. High data rate connectors are often used in backplane applications, as one example, that require high conductor densities and data rates. Many storage backplanes used with Serial Attached SCSI (SAS) and Serial AT Attachment (SATA) storage devices tend to be large, inhibit system cooling (e.g., forced air cooling), and result in other drawbacks. Many storage backplane systems also call for routing high-speed signals through backplane printed circuit boards (PCBs), which can result in significant Signal Integrity (SI) degradation, unless the backplane PCBs are manufactured with specialized materials and design techniques.

In the context outlined above, various aspects and embodiments of loop back connectors, loop back connector storage backplane systems, loop back backplane systems, and corresponding storage systems are described herein. An example connector includes a connector housing, a row of terminal conductors positioned within the connector housing, and a circuit board including a main connector tab positioned within the connector housing and a loop back connector tab that extends outside of the connector housing. The connector can also include a data cable with conductors coupled to contact pads on the circuit board in one example. In another example, the connector can include a data cable with conductors directly coupled to terminal conductors among the row of terminal conductors. An example storage system includes a backplane circuit board, a support shroud positioned over an aperture through the backplane circuit board, a card edge connector adjacent to the support shroud, and a loop back connector positioned within the support shroud with a loop back connector tab mated with the card edge connector.

The loop back connector concepts and systems described herein are designed to separate higher-speed differential data signals from lower-speed data and power signals on backplane circuit boards. The connectors and systems facilitate the direct electrical coupling of the higher-speed data signals to and from storage devices, bypassing the backplane PCB and the associated interconnect losses. The separation of the high-speed signals to a more direct, wired solution leads to a reduction in the physical size and complexity of storage backplane PCBs, lower system costs, improved system airflow and cooling, and other benefits. Since only relatively lower-speed data and power signals are carried over the backplane PCBs, lower cost PCB materials may be utilized, resulting in reduced costs and other benefits.

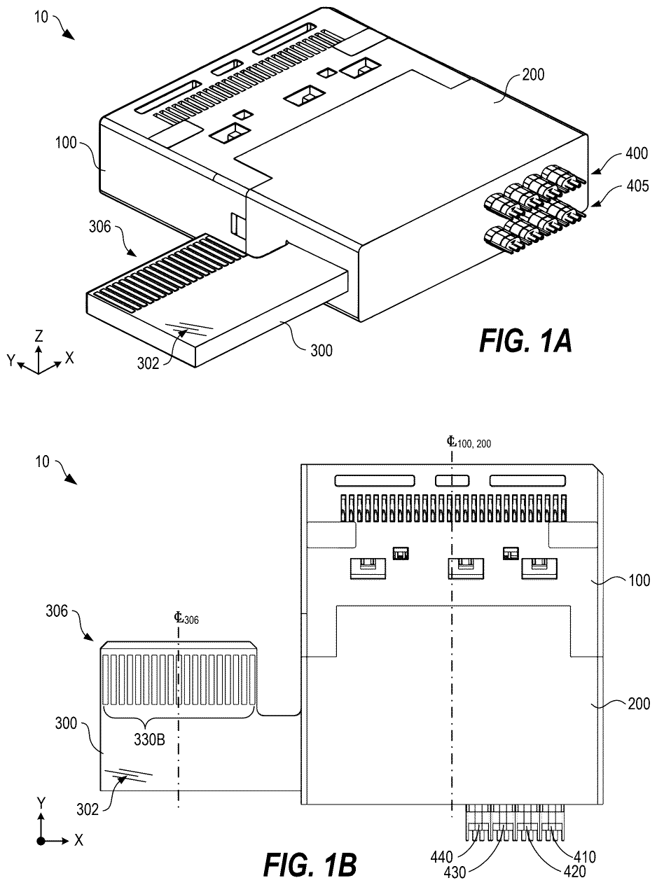

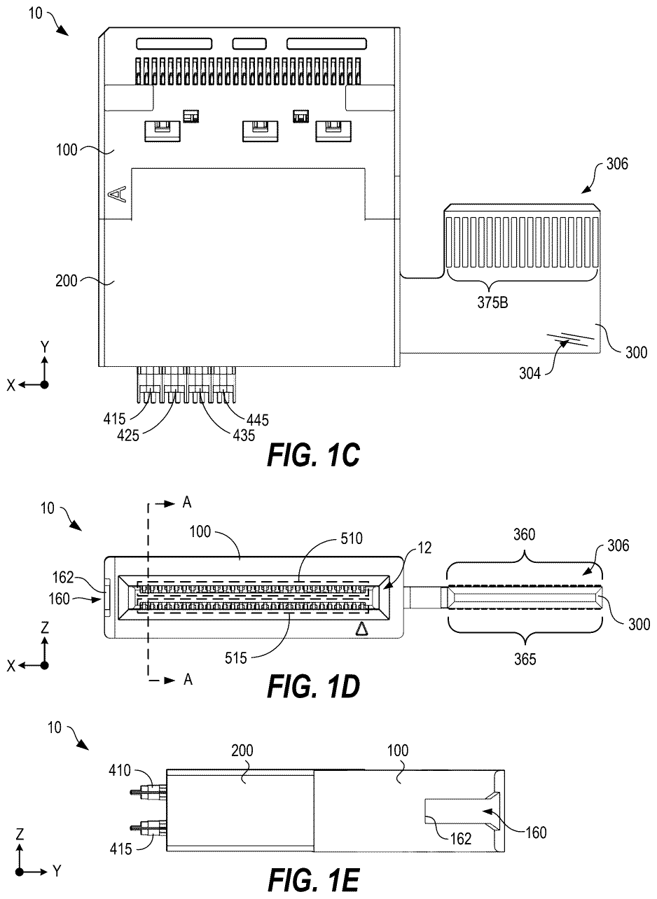

Turning to the drawings, FIG. 1A illustrates a perspective view of an example connector 10 according to various embodiments of the present disclosure. FIG. 1B illustrates a top view of the connector 10, FIG. 1C illustrates a bottom view of the connector 10, FIG. 1D illustrates a front view of the connector 10, and FIG. 1E illustrates a side view of the connector 10. The connector 10 is illustrated as a representative example and is not drawn to any particular scale or size in FIGS. 1A-1E. The shape, size, proportion, and other characteristics of the connector 10 can vary as compared to that shown. For example, the connector 10 can have a different shape, incorporate additional or fewer data cables, and incorporate larger or smaller rows of terminal conductors and contact pads (e.g., be wider or narrower), and other variations are within the scope of the examples described herein. A number of connectors similar to the connector 10 can be arranged side-by-side and/or stacked over one another for higher data rate interconnections. Additionally, one or more of the parts or components of the connector 10, as illustrated in the drawings and described herein, can be omitted in some cases. The connector 10 can also include other parts or components that are not illustrated.

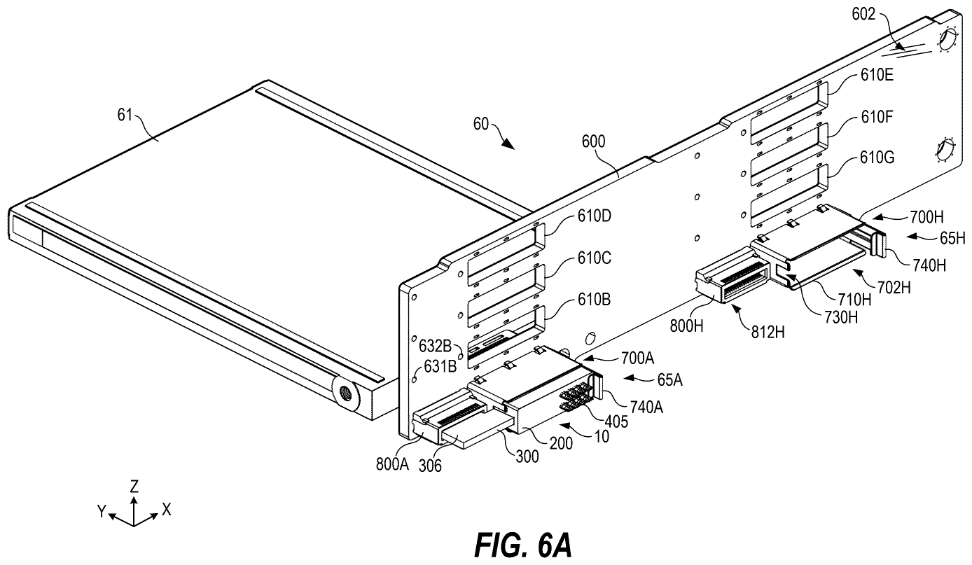

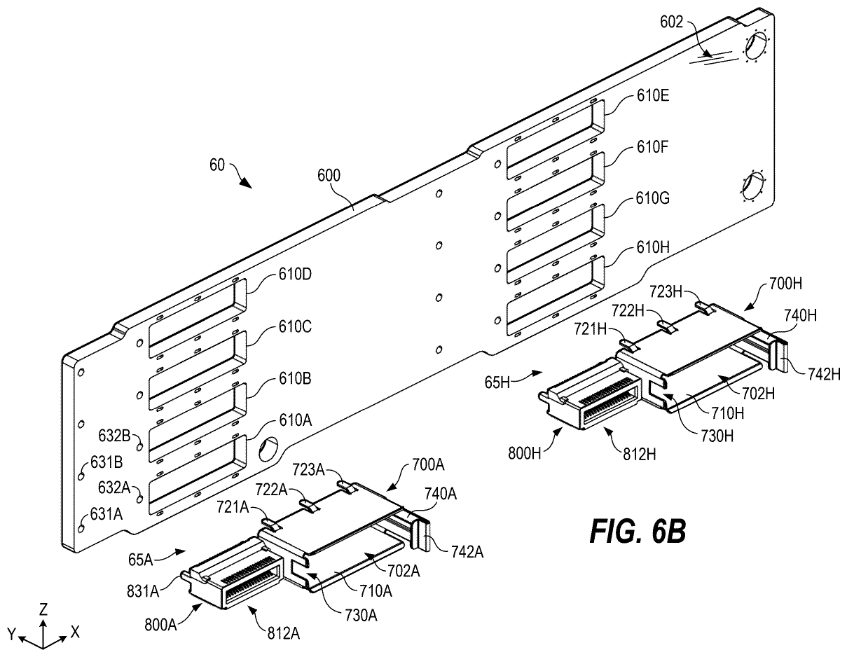

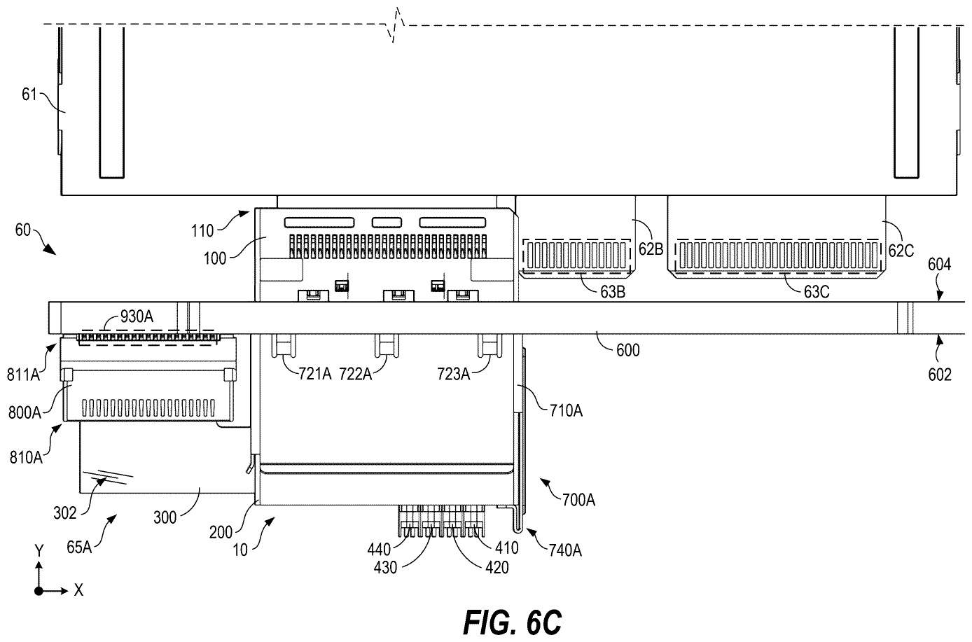

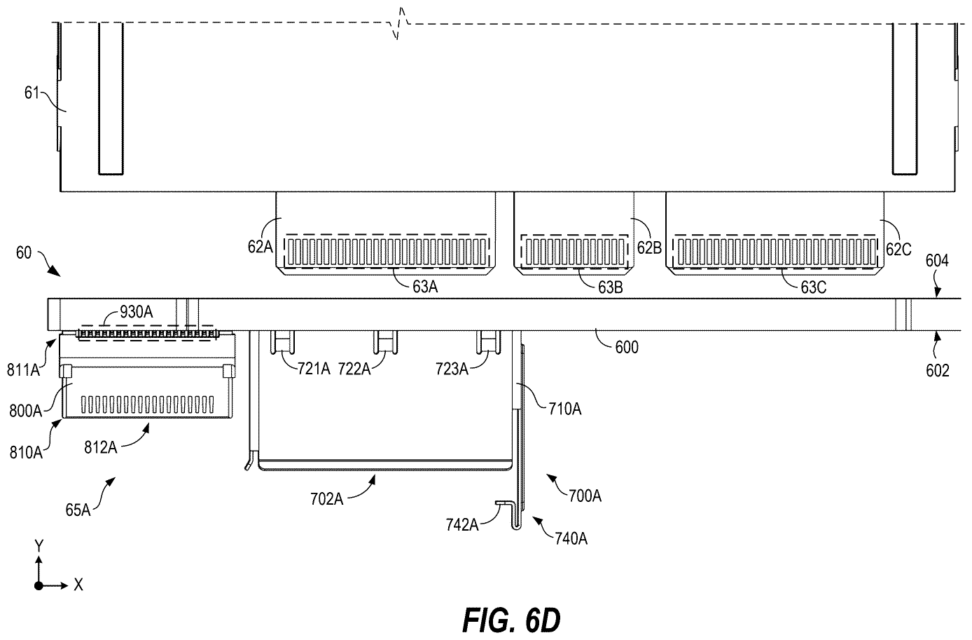

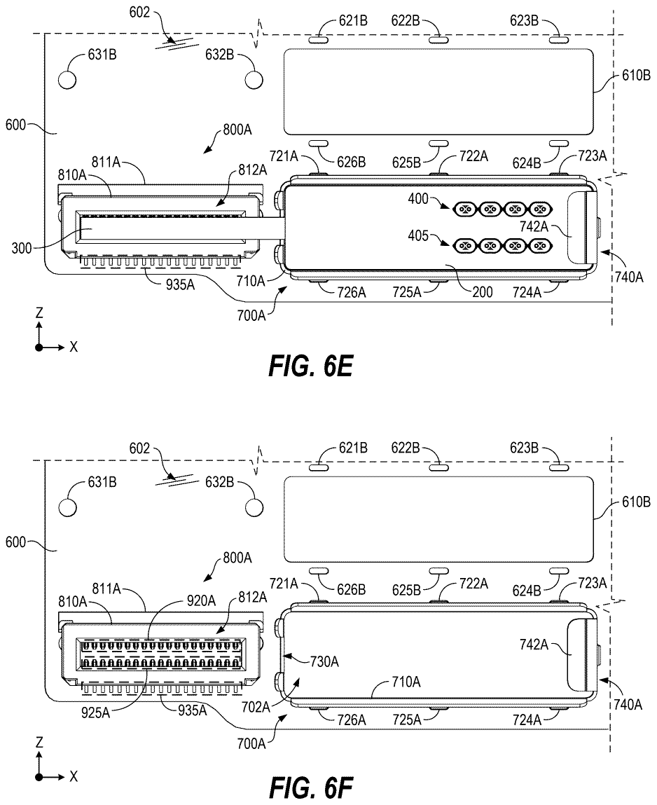

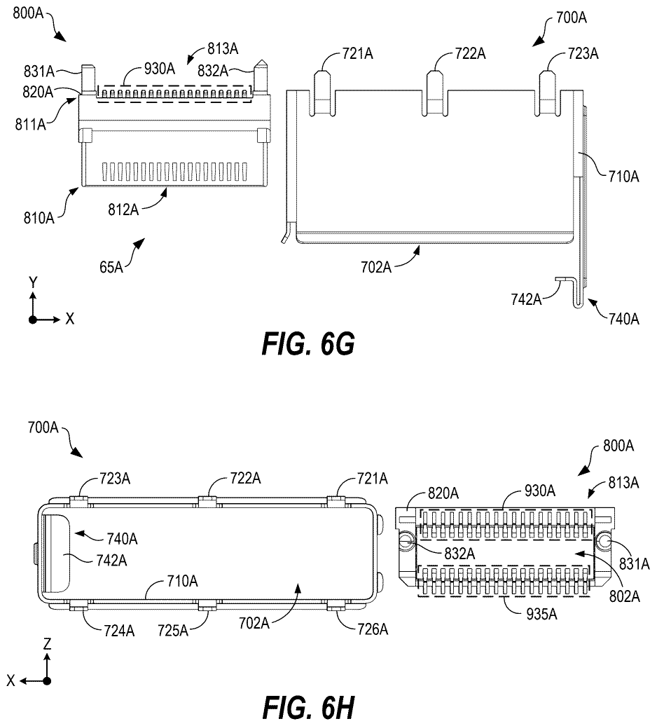

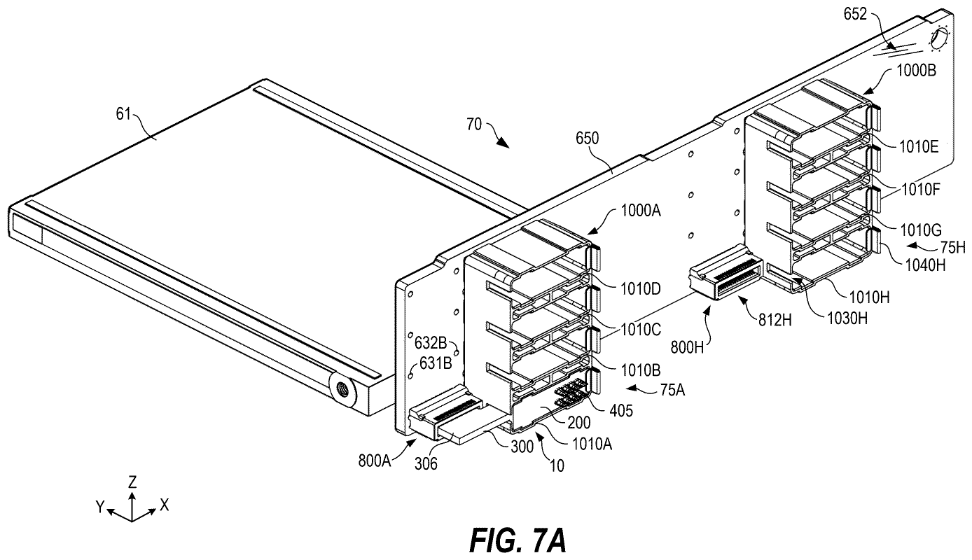

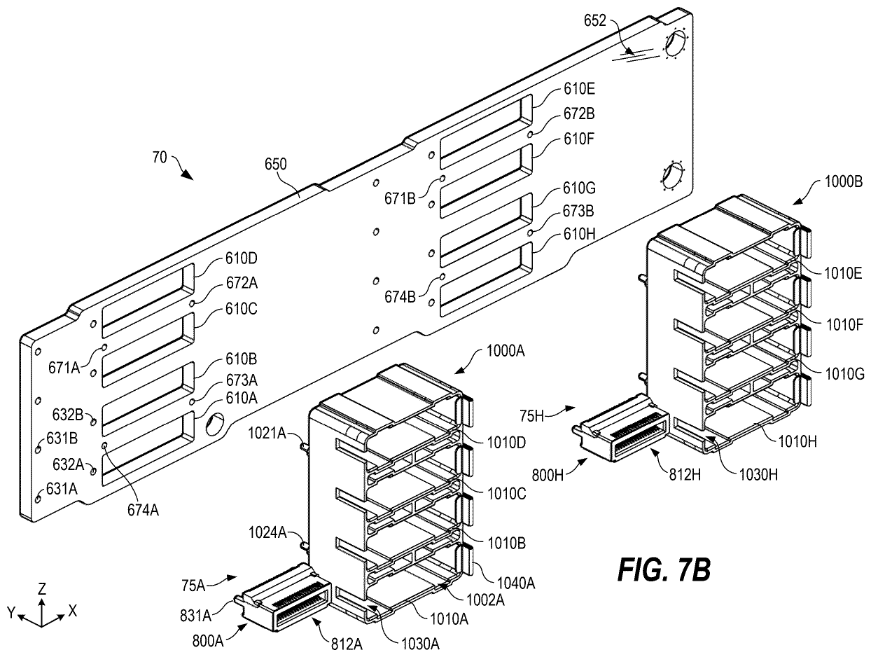

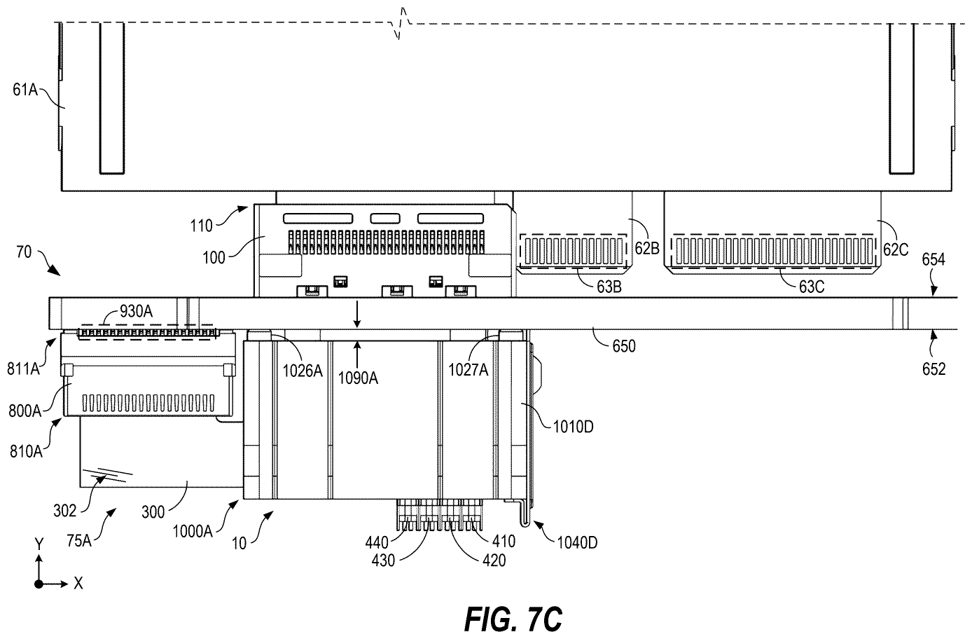

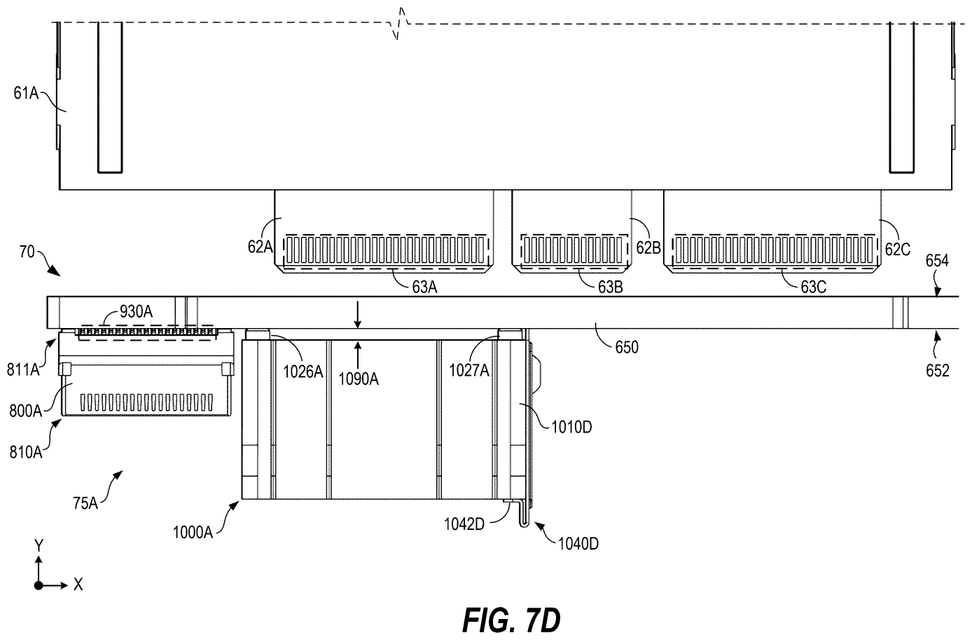

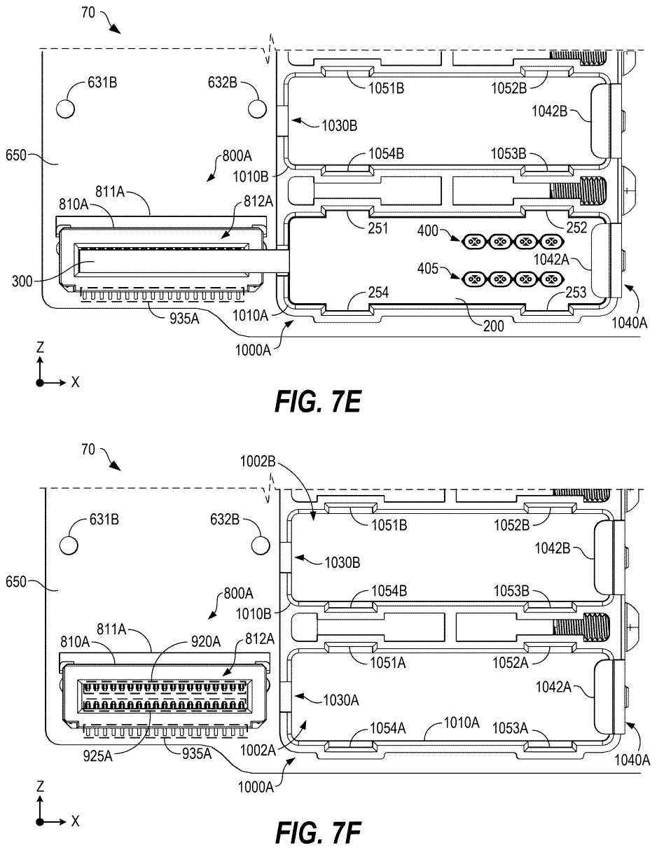

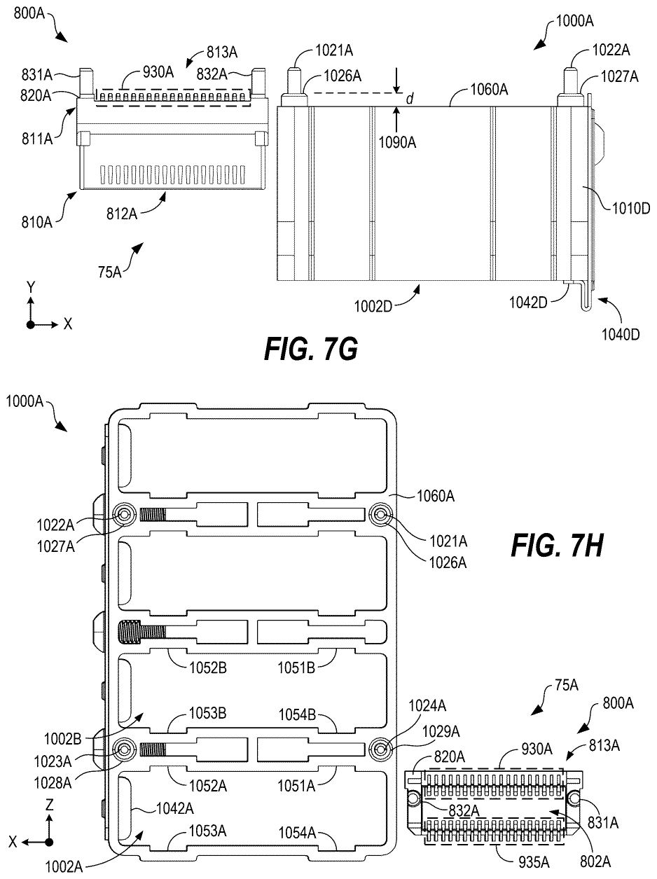

The connector 10 can be used to route high-speed data signals, low-speed data signals, power, and other signals through a backplane system. The backplane system can include the connector 10, other connectors similar to the connector 10, a backplane PCB, one or more support shrouds, one or more card edge connectors mounted to the backplane PCB, and other components described below with reference to FIGS. 6A and 7A. The connector 10 is designed to facilitate both the bypass of high-speed data signals apart from the backplane system, as well as the loop back of low-speed data signals through the connector 10 and into the backplane PCB, for distribution through the backplane PCB. The connector 10 bypasses high-speed data signals to cables, such as twinaxial cables, and loops back low-speed data signals to the backplane PCB through a card edge connector tab of the connector 10. Because the connector 10 bypasses high-speed data signals and loops back low-speed data signals, the connector 10 is referred to as a loop back connector 10. Also, a backplane system incorporating the connector 10 is referred to as a loop back storage backplane system.

Referring among FIGS. 1A-1E, the connector 10 includes a connector housing 100, an overmold housing 200, and a circuit board 300. Rows 400 and 405 of data cables extend and are electrically coupled to the connector 10. The row 400 includes data cables 410, 420, 430, and 440 (see FIG. 1B) and the row 405 includes data cables 415, 425, 435, and 445 (see FIG. 1C) in the example shown. Any suitable number of data cables can be terminated and coupled to the connector 10, or similar connectors according to the embodiments, in other examples. The data cables in the rows 400 and 405 can be embodied as twinaxial cables, in some examples, although other types of data cables can be relied upon in other cases. The data cables in the rows 400 and 405 are relied upon for the bypass of high-speed data signals through the connector 10 and away or apart from a backplane PCB, as described in further detail below. The data cables 410, 415, 420, 425, 430, 435, 440, and 445 can extend to any suitable length beyond the connector housing 100, although relatively short cables are illustrated for simplicity.

The connector housing 100 can be formed from a plastic or polymer, such as liquid crystal polymer (LCP), polyethylene (PE), polytetrafluoroethylene (PTFE), fluoropolymer, or other plastic or insulating material(s). The connector housing 100 can be formed using any suitable additive or subtractive manufacturing techniques, including molding, injection molding, printing, and other techniques. In some cases, outer surfaces or certain surface areas of the connector housing 100 can be plated with a plating metal or metals for conductivity, and the connector housing 100 can be embodied as a plated plastic component.

The overmold housing 200 is mechanically coupled to the connector housing 100 and formed around at least a portion of the circuit board 300 and the rows 400 and 405 of data cables in the example shown. The overmold housing 200 provides mechanical support and relief to the circuit board 300, the data cables in the rows 400 and 405, and other components of the connector 10. The overmold housing 200 can be molded around the circuit board 300 and the data cables in the rows 400 and 405 and, in part, molded into the connector housing 100. The overmold housing 200 can be formed from a plastic or other insulating material, in one example, although the overmold housing 200 can also be formed from combinations of insulating and non-insulating materials in some cases. The overmold housing 200 can be formed by a suitable manufacturing technique, such as molding, injection molding, printing, and other techniques. The overmold housing 200 can extend in part into an interior space within the connector housing 100 when formed.

The circuit board 300 can be embodied as a PCB, including a number of conductive metal and dielectric layers, laminated in an alternating arrangement together. The dielectric layers can be formed from a range of suitable dielectric materials, including PTFE laminates, ceramic-filled PTFE laminates, glass microfiber reinforced PTFE laminates, other suitable dielectric laminate materials, and combinations thereof. The metal layers can include metal traces, contact pads, and related features, and plated through-hole vias can be relied upon to electrically couple the metal traces, contact pads, and other features together. The circuit board 300 can include a number of exposed contact pads on the top and bottom sides or surfaces of the circuit board 300, as described below.

The circuit board 300 includes a top side or surface 302 and a bottom side or surface 304. The circuit board 300 also includes a loop back connector tab 306 (also “connector tab 306”) which forms a type of card edge interface of the connector 10. The connector tab 306 extends beyond and outside of the connector housing 100 and the overmold housing 200. The loop back connector tab 306 is relied upon for the loop back of low-speed data signals through the connector 10 and to a backplane PCB, as described in further detail below. A centerline ℄₃₀₆ of the connector tab 306 is offset from and parallel to a corresponding centerline ℄100.200 of the connector housing 100 and the overmold housing 200 in the example depicted, although the connector tab 306 may have a different configuration in other cases. The circuit board 300 also includes a main connector tab 308. The main connector tab 308 is inserted into and positioned within an interior space of the connector housing 100 when the connector 10 is assembled as shown in FIGS. 1A-1E.

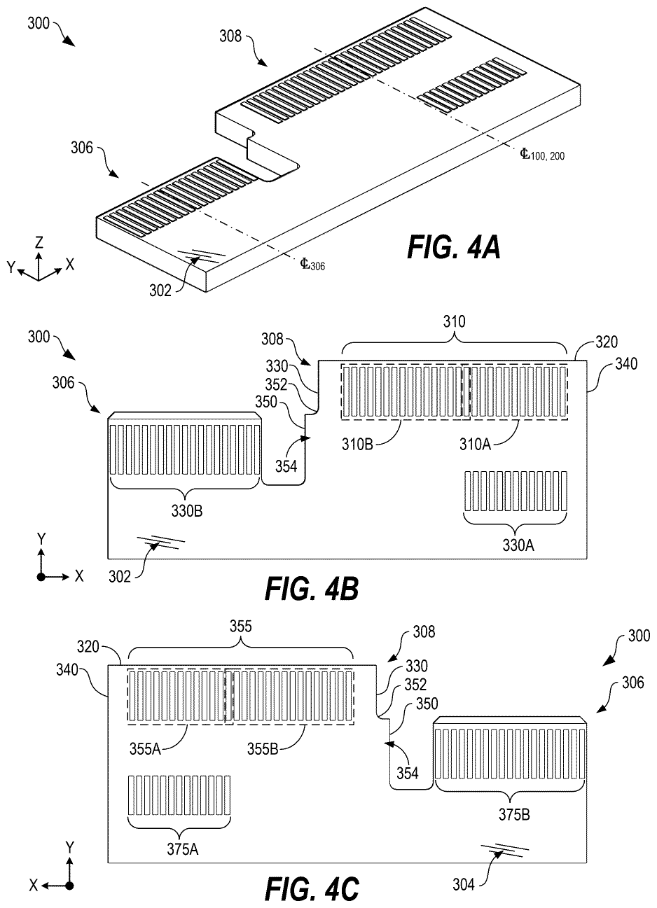

As described in further detail below with reference to FIGS. 4A to 4C, the circuit board 300 includes groups of contact pads formed at different locations on the top side 302 and the bottom side 304. Referring to FIGS. 1B and 1C for an example, the circuit board 300 includes a group 330B of contact pads formed on the top side 302 and a group 375B of contact pads formed on the bottom side 304. The groups 330B and 375B of contact pads can vary in shape, size, number of contact pads, and be positioned at different locations on the connector tab 306 in some cases. The connector tab 306 and the groups 330B and 375B of contact pads can be embodied and implemented together as a type of PCB-style, card edge connector interface of the connector 10 for data signal loop back.

Referring to FIG. 1D, the connector housing 100 of the connector 10 includes a front port opening 12. Wafer assemblies are positioned within the connector housing 100, as described in further detail below. Terminal rows 510 and 515 of terminal conductors of the wafer assemblies are visible within the front port opening 12. The front port opening 12 and the terminal rows 510 and 515 are designed to mate with a card edge interface of a storage device, among other types of devices. The card edge interface of a storage device can be inserted into the front port opening 12, and electrical connections are established between the terminal rows 510 and 515 and contact pads on the card edge interface of the storage device. As a more particular example, the front port opening 12 and terminal rows 510 and 515 can be designed to mate with a card edge interface defined by the SFF-TA-1002 specification. The connector 10 can be designed to mate with a range of other standard and non-standard interfaces, however, and the loop back connector concepts described herein are not limited to use with any particular electrical or form factor specifications.

The connector housing 100 also includes a channel 160 formed on a side of the connector housing 100. The channel 160 can be formed (e.g., sized, shaped, and positioned) to mechanically interface with a mating connector of a storage device, as described in further detail below. As shown in FIG. 1E, the channel 160 extends along an external side of the connector housing 100 from the front port opening 12 to a stop 162 that defines an end of the channel 160.

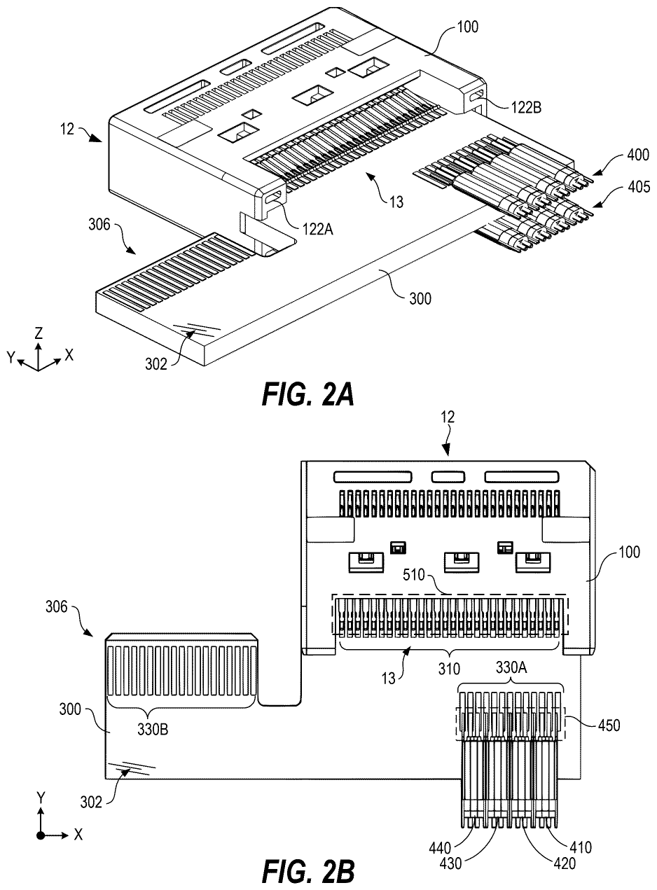

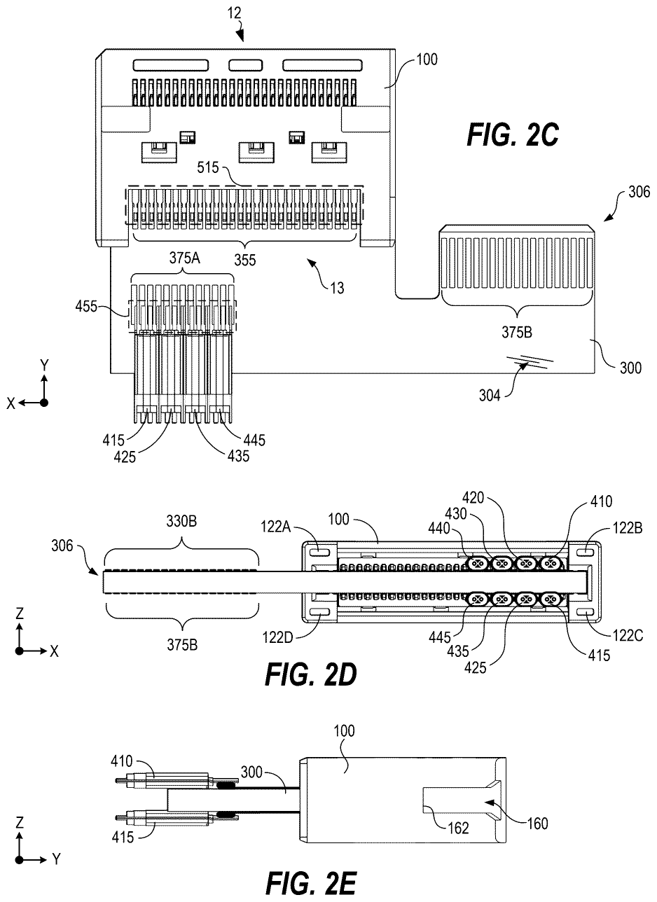

FIG. 2A illustrates a perspective view of the connector 10 shown in FIG. 1A with the overmold housing 200 omitted from view. FIG. 2B illustrates a top view of the connector 10 shown in FIG. 2A, FIG. 2C illustrates a bottom view of the connector 10 shown in FIG. 2A, FIG. 2D illustrates a back view of the connector 10 shown in FIG. 2A, and FIG. 2E illustrates a side view of the connector 10 shown in FIG. 2A. The termination of the data cables 410, 415, 420, 425, 430, 435, 440, and 445 to the circuit board 300 of the connector 10 is visible in FIGS. 2A-2E, because the overmold housing 200 is omitted from view.

Referring among FIGS. 2A to 2C, the connector 10 includes the front port opening 12 at the front of the connector housing 100 and a terminal foot 13 at the back of the connector housing 100. As noted above, the connector 10 is designed to establish and maintain electrical connections with the card edge interface of a storage device, which is inserted into the front port opening 12. Electrical connections are established between the terminal rows 510 and 515 and contact pads on the card edge interface of the storage device within the front port opening 12. At the terminal foot 13, electrical connections are established between the terminal rows 510 and 515 and contact pads on the circuit board 300, as described in further detail below.

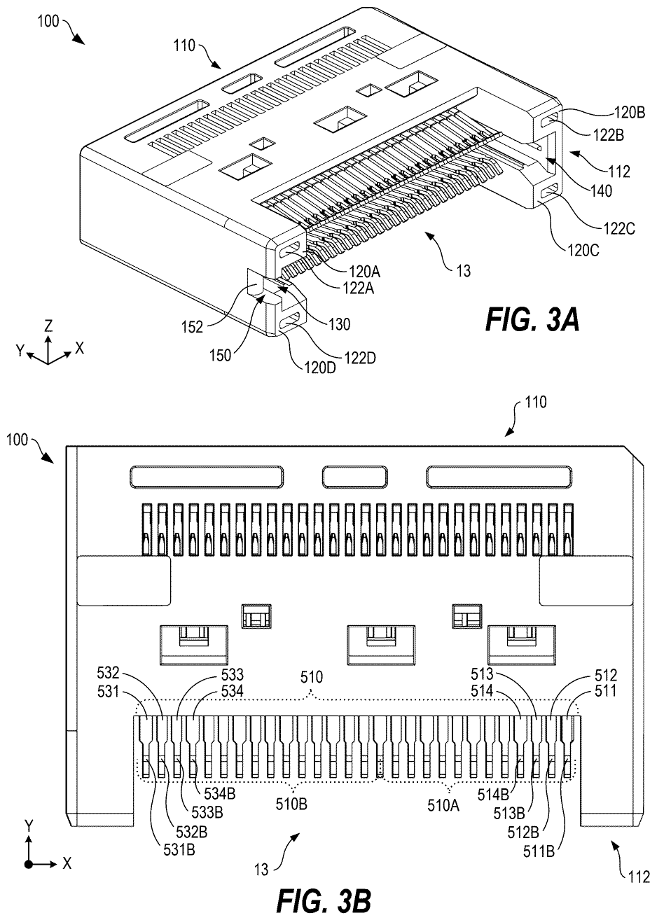

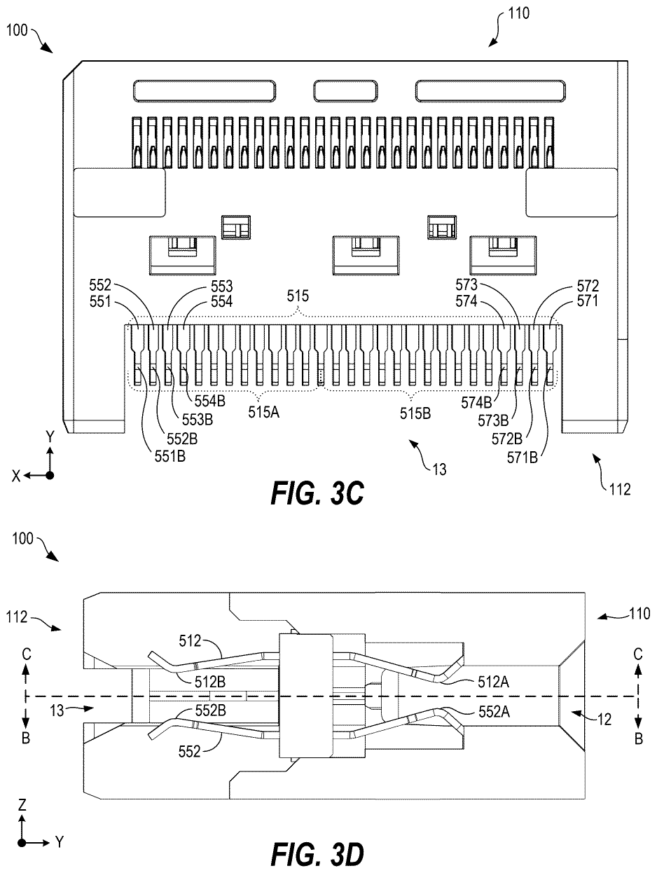

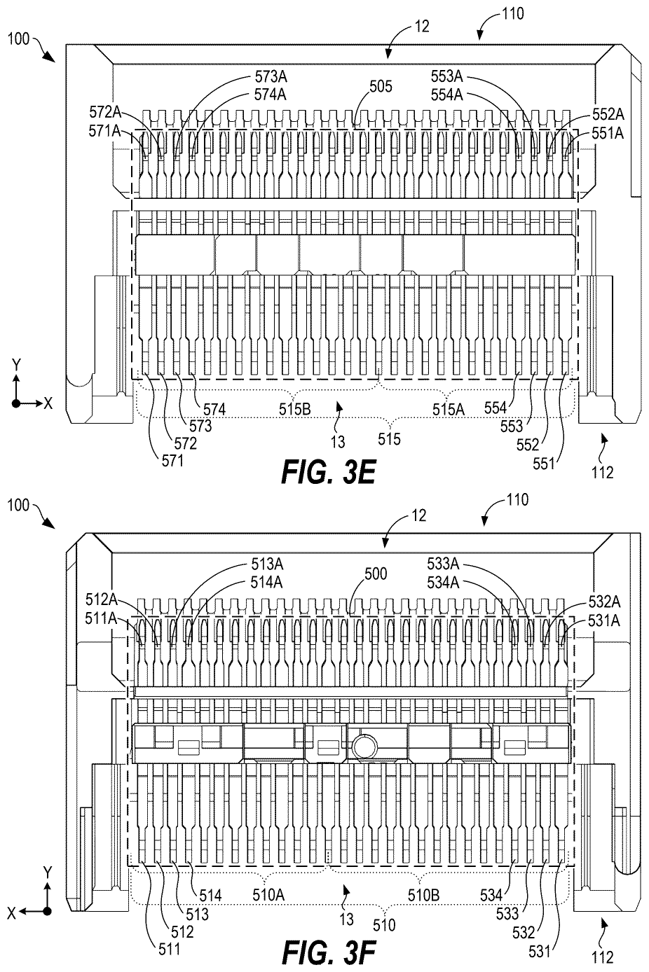

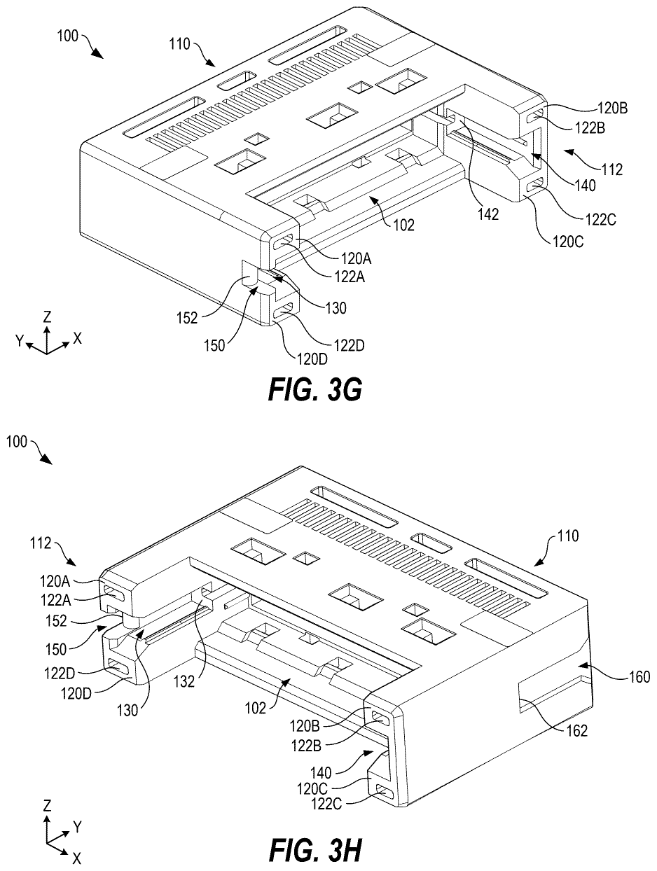

The connector 10 includes wafer assemblies that are positioned and secured inside the connector housing 100. The wafer assemblies include the terminal rows 510 and 515 of terminal conductors. The terminal rows 510 and 515 extend from the front port opening 12 to the terminal foot 13, for the communication of data signals through the connector 10. FIG. 1D illustrates a front view of the terminal rows 510 and 515 of the wafer assemblies within the connector housing 100. The terminal conductors of the terminal rows 510 and 515 are described in further detail below with reference to FIGS. 3A to 3F. The connector 10 is designed to provide shielding and maintain the signal integrity of differential signals on the terminal conductors, as they extend from the front port opening 12 to the terminal foot 13. The terminal foot 13 of the connector 10 is designed for contact coupling (e.g., spring-biased, metal-to-metal wipe contact) with contact pads on the top and bottom sides 302 and 304 of the circuit board 300 in the example depicted. The tail ends of the terminal conductors at the terminal foot 13 can also be designed to have through-hole tail ends or other lead styles for coupling to the circuit board 300 in other cases.

The connector 10 also includes features to maintain the alignment and position of the terminal rows 510 and 515 of terminal conductors and the circuit board 300 within the connector 10. The wafers in the connector 10 are designed to maintain the alignment, position, mechanical and electrical compliance, and robustness of each terminal conductor in the terminal rows 510 and 515 within the connector housing 100.

A portion of the circuit board 300 is positioned within the connector housing 100 at the terminal foot 13. As described in further detail below with reference to FIGS. 4A to 4C, the circuit board 300 includes a main connector tab that is positioned within the connector housing 100 and includes contacts coupled to the terminal conductors of the terminal rows 510 and 515 at the terminal foot 13. The connector housing 100 can include one or more guide channels, recesses, slots, apertures, stops, or some combination thereof that mechanically interface with and position the main connector tab of the circuit board 300 with respect to the terminal foot 13 within the connector housing 100.

The data cables in the row 400 include signal conductors and drain or ground conductors, which are referenced as the conductors 450 in FIG. 2B. The conductors 450 are coupled to the top side 302 of the circuit board 300. More particularly, each of the conductors 450 is individually coupled to a contact pad among a group 330A of contact pads on the top side 302 of the circuit board 300. The conductors 450 can be electrically coupled to the group 330A of contact pads using any suitable approach, such as soldering, sintering, welding, conductive adhesives, or other approaches. Similarly, the data cables in the row 405 include signal conductors and drain or ground conductors, which are referenced as the conductors 455 in FIG. 2C. The conductors 455 are coupled to the bottom side 304 of the circuit board 300. More particularly, each of the conductors 455 is individually coupled to a contact pad among a group 375A of contact pads on the bottom side 304 of the circuit board 300. The conductors 455 can be electrically coupled to the group 375A of contact pads using any suitable approach, such as soldering, sintering, welding, conductive adhesives, or other approaches.

FIG. 3A illustrates a perspective view of the connector housing 100 and the terminal rows 510 and 515 of terminal conductors of the connector 10 shown in FIG. 1A according to various embodiments of the present disclosure. FIG. 3B illustrates a top view of the connector housing 100 and the terminal row 510 of terminal conductors, and FIG. 3C illustrates a bottom view of the connector housing 100 and the row 515 of terminal conductors. FIG. 3D illustrates the cross-sectional view of the connector housing 100 and the rows 510 and 515 of terminal conductors designated A-A in FIG. 1D. FIG. 3E illustrates the cross-sectional view of the connector housing 100 designated B-B in FIG. 3D, and FIG. 3F illustrates the cross-sectional view of the connector housing 100 designated C-C in FIG. 3D. FIG. 3G illustrates a perspective view of the connector housing 100 shown in FIG. 3A with the wafer assemblies omitted from view. FIG. 3H illustrates another perspective view of the connector housing 100 shown in FIG. 3A with the wafer assemblies omitted from view. The wafer assemblies are omitted from view in FIGS. 3G and 3H, to better illustrate internal features within the connector housing 100.

Referring between FIGS. 3A and 3G, the connector housing 100 includes an internal region 102 (see FIG. 3G) of space in which the wafer assembly 500 (see FIG. 3F) and the wafer assembly 505 (see FIG. 3E) are positioned when the connector 10 is assembled. The main connector tab 308 of the circuit board 300 is also positioned between the rows 510 and 515 of the terminal conductors at the terminal foot 13 when the connector 10 is assembled. The connector housing 100 also includes a front port end 110, a base end 112, base mounting surfaces 120A, 120B, 120C, and 120D, and mounting apertures 122A, 122B, 122C, and 122D. The overmold housing 200 can be molded around the circuit board 300 and the data cables in the rows 400 and 405. When the overmold housing 200 is formed, the overmold housing 200 can also be formed, in part, to extend into the connector housing 100. For example, the material from which the overmold housing 200 is formed can flow and extend into the mounting apertures 122A, 122B, 122C, and 122D of the connector housing 100.

The connector housing 100 is embodied as a type of straddle mount connector and includes features to guide a PCB into the terminal foot 13 at the back of the connector housing 100. The connector housing 100 can include one or more guide channels, recesses, slots, apertures, stops, or other features that mechanically interface with and position the main connector tab 308 of the circuit board 300 at the terminal foot 13 of the connector housing 100. The connector housing 100 in the example shown includes a first datum channel 130 formed in one end side of the connector housing 100 and a second datum channel 140 formed in another, opposite end side of the connector housing 100. The datum channels 130, 140 (also “channels 130, 140”) are formed as recessed channels in the end sides of the connector housing 100 within the internal region 102 of the connector housing 100. The connector housing 100 also includes a channel slot 150 (also “slot 150”) formed in an end side of the base end 112 of the connector housing 100 between the base mounting surfaces 120A and 120C. The slot 150 is formed as a slot or recessed channel in the end side of the base end 112 and at least partly within the internal region 102 of the connector housing 100.

The channels 130 and 140 extend within the internal region 102 from the base mounting surfaces 120A, 120B, 120C, and 120D of the connector housing 100 toward the front port opening 12. The channel 130 extends within the internal region 102 from the base mounting surfaces 120A and 120D to a circuit board stop 132 (see FIG. 3H) that partly defines one end of the channel 130. The channel 140 extends within the internal region 102 from the base mounting surfaces 120B and 120C to a circuit board stop 142 (see FIG. 3H) that partly defines one end of the channel 140. The slot 150 extends within the internal region 102 from the base mounting surfaces 120A and 120C to a circuit board stop 152 that partly defines one end of the slot 150. Any or all of the circuit board stops 132, 142, and 152 can be embodied as a flat surface in some examples or as a curved or angled surface in other examples. The circuit board stops 132 and 142 are each embodied as a flat surface and the circuit board stop 152 is embodied as a curved surface in the example shown.

The length, width, and depth of the channels 130, 140 and the slot 150 can vary among the embodiments. The direction of the channels 130, 140 and the slot 150 can also vary in some cases as compared to that shown. The channels 130, 140, the slot 150, and the circuit board stops 132, 142, and 152 are formed to cooperate with portions of the circuit board 300, to position and secure the circuit board 300 in place within the internal region 102 of the connector housing 100. The channels 130, 140, the slot 150, and the stops 132, 142, 152 are also formed to position the main connector tab 308 of the circuit board 300 in place between the terminal rows 510 and 515 of the wafer assemblies 500 and 505, respectively, as described in further detail below.

The connector housing 100 also includes a channel 160 formed on a side of the connector housing 100 (see FIG. 3H). The channel 160 can be embodied in some examples to mechanically interface with a component that is external to the connector 10, such as a card edge interface of a storage device. The channel 160 can be embodied in other examples to allow gaps (e.g., clearances) between surfaces within the channel 160 and surfaces of the component external to the connector 10. The channel 160 extends along an external side of the connector housing 100 from the front port end 110 to the stop 162. The stop 162 can be embodied as a flat surface in some examples or as a curved or angled surface in other examples.

Wafer assemblies are positioned within the connector housing 100. FIG. 3E illustrates the cross-sectional view of the connector housing 100 designated B-B in FIG. 3D, and a first wafer assembly 505 is shown in FIG. 3E. The wafer assembly 505 includes the terminal row 515, among other components. FIG. 3F illustrates the cross-sectional view of the connector housing 100 designated C-C in FIG. 3D, and a second wafer assembly 500 is shown in FIG. 3E. The wafer assembly 500 includes the terminal row 510, among other components.

The wafer assembly 500 supports, spaces, and aligns terminal conductors in the terminal row 510. Similarly, the wafer assembly 505 supports, spaces, and aligns terminal conductors in the terminal row 515. The wafer assemblies 500 and 505 are illustrated as representative examples and are not drawn to any particular scale or size. The shape, size, proportion, and other characteristics of the wafer assemblies 500 and 505 can vary as compared to that shown. For example, the wafer assemblies 500 and 505 can accommodate larger or smaller rows of terminals (e.g., be wider or narrower), and other variations are within the scope of the examples described herein. Additionally, one or more of the parts or components of the wafer assemblies 500 and 505, as illustrated in the drawings and described herein, can be omitted in some cases. The wafer assemblies 500 and 505 can also include other parts or components that are not illustrated.

In some cases, the wafer assemblies 500 and 505 can be arranged and constructed in a similar way using duplicated components. Thus, the same materials and tooling can be relied upon to form both the wafer assemblies 500 and 505, reducing the overall cost and complexity of the connector 10. Additionally, the lengths and shapes of the terminal conductors in terminal row 510 can be the same as the lengths and shapes of the terminal conductors in terminal row 515. In other cases, however, the wafer assemblies 500 and 505 can differ from each other in one or more aspects, such as in the sizes, shapes, positions, spacings, and numbers of terminal conductors, in the sizes, shapes, and other characteristics of the wafer mold inserts, in the positions and structures of the flexible and rigid shields, in the structure and format of the ground path assemblies, and other aspects.

Referring to FIG. 3F, the terminal row 510 includes a row of terminal conductors, including signal and ground terminals. The terminal row 510 can also include power terminals in some cases. The signal, ground, and power terminals in the terminal row 510 each include a lead contact at one distal end (i.e., positioned at the front port opening 12 of the connector 10 shown in FIG. 3F) and a tail contact at another distal end (i.e., positioned at the terminal foot 13). The signal, ground, and power terminals in the terminal row 510 are electrically isolated from each other within the connector 10. The tail contacts are designed for contact coupling (e.g., spring-biased, metal-to-metal wipe contact) with contact pads on the circuit board 300. The tail ends can also be designed to have through-hole tail ends or other lead styles for coupling to the circuit board 300 in other cases.

The terminal row 510 includes a first group 510A of terminal conductors and a second group 510B of terminal conductors. The groups 510A and 510B include ground and signal terminals. In some cases, one or both of the groups 510A and 510B can also include terminal conductors for power. In one example, the group 510A includes a ground terminal conductor 511, signal terminal conductors 512 and 513 that form a differential pair of signal conductors, and a ground terminal conductor 514. The terminal conductors 511-514 include lead contacts 511A-514A, respectively, positioned at the front port opening 12 of the connector 10, and tail contacts 511B-514B (see FIG. 3B), respectively, positioned at the terminal foot 13 of the connector 10. The terminal conductors 511 and 514 are ground conductors in the terminal row 510, and the terminal conductors 512 and 513 are signal conductors in the terminal row 510. The signal terminal conductors 512 and 513 are positioned between the ground terminal conductors 511 and 514, as shown. A ground terminal conductor may be shared among the groups 510A and 510B of terminal conductors as in the example shown. The terminal row 510 includes eighteen (18) signal conductors and ten (10) ground conductors in total. The number of terminal conductors in the terminal row 510 and the groups 510A and 510B can vary as compared to that shown and described, however, and the use of other numbers of terminal conductors is within the scope of the embodiments.

Collectively, the group 510A includes eight (8) signal conductors and five (5) ground conductors, for a total of thirteen (13) terminal conductors, and each pair of the signal conductors is positioned side-by-side between two ground conductors. The terminal conductors 511-514 and other terminal conductors in the group 510A can be used to communicate differential data signals having a range of different data rates and signaling formats. The terminal conductors 511-514 in the group 510A can be used in one example to communicate relatively high-speed differential data signals. The terminal conductors of the group 510A are also referred to herein as “bypass terminal conductors.”

The group 510B is similar to the group 510A. Among other terminal conductors, the group 510B includes a ground terminal conductor 531, signal terminal conductors 532 and 533 that form a differential pair of signal conductors, and a ground terminal conductor 534. The terminal conductors 531-534 include lead contacts 531A-534A, respectively, positioned at the front port opening 12 of the connector 10, and tail contacts 531B-534B (see FIG. 3B), respectively, positioned at the terminal foot 13 of the connector 10. The terminal conductors 531 and 534 are ground conductors in the terminal row 510, and the terminal conductors 532 and 533 are signal conductors in the terminal row 510. The signal terminal conductors 532 and 533 are positioned between the ground terminal conductors 531 and 534, as shown.

Collectively, the group 510B includes ten (10) signal conductors and six (6) ground conductors, for a total of sixteen (16) terminal conductors, and each pair of the signal conductors is positioned side-by-side between two ground conductors. The terminal conductors 531-534 and other conductors in the group 510B can be used to communicate differential data signals having a range of different data rates and signaling formats. The terminal conductors 531-534 and other conductors in the group 510B can be used in one example to communicate relatively low-speed differential data signals, power signals, sideband signals, or other signals. The terminal conductors of the group 510B are also referred to herein as “loop back terminal conductors.”

The pitch between the lead contacts of the terminal conductors is the same in both the terminal rows 510 and 515 in one example. However, the terminal conductors in the terminal row 510 can be offset from those in the terminal row 515 in some cases, such that the lead contacts are staggered between the rows. In other cases, the terminal conductors in the terminal rows 510 and 515 may have the same pitch and be aligned (i.e., not staggered) with respect to each other. In still other cases, the terminal conductors in the terminal rows 510 and 515 may have different lead contact pitches as compared to each other.

Referring to FIG. 3E, the wafer assembly 505 includes the terminal row 515, among other components. The wafer assembly 505 supports, spaces, and aligns terminal conductors in the terminal row 515. The terminal row 515 of the wafer assembly 505 is similar to the terminal row 510 of the wafer assembly 500. The terminal row 515 includes a row of terminal conductors, including signal and ground terminals. The terminal row 515 can also include power terminals in some cases. The signal, ground, and power terminals in the terminal row 515 each include a lead contact at one distal end (i.e., positioned at the front port opening 12 of the connector 10 shown in FIG. 3E) and a tail contact at another distal end (i.e., positioned at the terminal foot 13). The signal, ground, and power terminals in the terminal row 515 are electrically isolated from each other within the connector 10. The terminal conductors extend, starting from the lead contacts at the front port opening 12, to the tail contacts at the terminal foot 13 of the connector 10. The tail contacts are designed for contact coupling (e.g., spring-biased, metal-to-metal wipe contact) with contact pads on the circuit board 300. The tail ends can also be designed to have through-hole tail ends or other lead styles for coupling to the circuit board 300 in other cases.

The terminal row 515 includes a first group 515A of terminal conductors and a second group 515B of terminal conductors. The groups 515A and 515B include ground and signal terminals. In some cases, one or both of the groups 515A and 515B can also include terminal conductors for power. In one example, the group 515A includes a ground terminal conductor 551, signal terminal conductors 552, 553 that form a differential pair of signal conductors, and a ground terminal conductor 554. The terminal conductors 551-554 include lead contacts 551A-554A, respectively, positioned at the front port opening 12 of the connector 10, and tail contacts 551B-554B, respectively, positioned at the terminal foot 13 of the connector 10. The terminal conductors 551 and 554 are ground conductors in the terminal row 515, and the terminal conductors 552 and 553 are signal conductors in the terminal row 515. The signal terminal conductors 552 and 553 are positioned between the ground terminal conductors 551 and 554, as shown. A ground terminal conductor may be shared among the groups 515A and 515B of terminal conductors as in the example shown. The terminal row 515 includes eighteen (18) signal conductors and ten (10) ground conductors in total.

Collectively, the group 515A includes eight (8) signal conductors and five (5) ground conductors, for a total of thirteen (13) terminal conductors, and each pair of the signal conductors is positioned side-by-side between two ground conductors. The terminal conductors 551-554 and other terminal conductors in the group 515A can be used to communicate differential data signals having a range of different data rates and signaling formats. The terminal conductors 551-554 and other conductors in the group 515A can be used in one example to communicate relatively high-speed differential data signals. The terminal conductors of the group 515A are also referred to herein as “bypass terminal conductors.”

The group 515B is similar to the group 515A. Among other terminal conductors, the group 515B includes a ground terminal conductor 571, signal terminal conductors 572 and 573 that form a differential pair of signal conductors, and a ground terminal conductor 574. The terminal conductors 571-574 include lead contacts 571A-574A, respectively, positioned at the front port opening 12 of the connector 10, and tail contacts 571B-574B, respectively, positioned at the terminal foot 13 of the connector 10. The terminal conductors 571 and 574 are ground conductors in the terminal row 515, and the terminal conductors 572 and 573 are signal conductors in the terminal row 515. The signal terminal conductors 572 and 573 are positioned between the ground terminal conductors 571 and 574, as shown.

Collectively, the group 515B includes ten (10) signal conductors and six (6) ground conductors, for a total of sixteen (16) terminal conductors, and each pair of the signal conductors is positioned side-by-side between two ground conductors. The terminal conductors 571-574 and other conductors in the group 515B can be used in various examples to communicate differential data signals having a range of different data rates and signaling formats. The terminal conductors 571-574 and other conductors in the group 515B can be used in one example to communicate at least one of relatively low-speed differential data signals, power signals, sideband signals, or other signals. The terminal conductors of the group 515B are also referred to herein as “loop back terminal conductors.”

The groups 510A, 510B, 515A, and 515B of terminal conductors are identified as representative examples in FIGS. 3E and 3F. The individual terminal conductors among the terminal rows 510 and 515 of the connector 10 can be organized or grouped in other ways for loop back and bypass purposes, as needed. As also described below, the data signals carried on the terminal rows 510 and 515 are electrically coupled to contact pads on the circuit board 300. The data signals are routed through the circuit board 300 for either loop back or bypass data communication. According to one example, the terminal conductors in groups 510A and 515A carry high-speed data signals that are routed through the circuit board 300 to contact pads for coupling to the rows 400 and 405 of data cables. The rows 400 and 405 of data cables are relied upon for bypassing data signals apart from a backplane PCB. On the other hand, the terminal conductors in groups 510B and 515B carry low-speed data signals that are routed through the circuit board 300 to the groups 330B and 375B (see FIGS. 2B and 2C) of contact pads on the loop back connector tab 306. The loop back connector tab 306 is relied upon for loop back coupling of data signals to a backplane PCB. These and other aspects of the embodiments are described in further detail below.

FIG. 4A illustrates a perspective view of the circuit board 300 shown in FIG. 1A, FIG. 4B illustrates a top view of the circuit board 300, and FIG. 4C illustrates a bottom view of the circuit board 300. The circuit board 300 includes the loop back connector tab 306 and the main connector tab 308. The loop back connector tab 306 extends outside of (i.e., beyond the outer surfaces of) the connector housing 100 and the overmold housing 200 when the connector 10 is assembled. The main connector tab 308 is defined in part by a front edge 320 of the circuit board 300. The main connector tab 308 is also defined in part by sides 330 and 340 of the circuit board 300. Adjacent the side 330 is a housing stop 352 formed on the circuit board 300, and adjacent the housing stop 352 is another side 350 of the circuit board 300. The housing stop 352 is embodied as a curved surface or recess in the example shown, although in some cases the housing stop 352 may be formed as a flat or angled surface.

The main connector tab 308 of the circuit board 300 is inserted into the internal region 102 of the connector housing 100 and between the rows 510 and 515 of the terminal conductors at the terminal foot 13 when the connector 10 is assembled. When fully inserted, the front edge 320 of the circuit board 300 mechanically interfaces with (e.g., contacts and abuts against) the circuit board stops 132 and 142 (see FIGS. 3G and 3H) in the internal region 102 of the connector housing 100. Along with the top and bottom sides 302 and 304 of the circuit board 300, the sides 330 and 340 mechanically interface with and are guided and supported by the channels 130 and 140, respectively, in the internal region 102 of the connector housing 100.

A region 354 of the circuit board 300 is defined by the side 350, the housing stop 352, and the top and bottom sides 302 and 304. The region 354 mechanically interfaces with and is supported by the slot 150 formed in the base end 112 of the connector housing 100. The housing stop 352 mechanically interfaces with (e.g., contacts and abuts against) the circuit board stop 152 (see FIG. 3G) formed at an end of the slot 150 in the base end 112 of the connector housing 100. The front edge 320, sides 330, 340, and 350, and the housing stop 352 on the circuit board 300, along with the channels 130 and 140, the slot 150, and the circuit board stops 132, 142, and 152 on the connector housing 100 are designed to position and secure the main connector tab 308 between the terminal rows 510 and 515 at the terminal foot 13 within the internal region 102 of the connector housing 100.

The circuit board 300 also includes groups of contact pads formed at different locations on the top side 302 and the bottom side 304. On the top side 302 shown in FIG. 4B, the circuit board 300 includes contact pads 310 positioned on the main connector tab 308. Among the contact pads 310, the circuit board 300 includes a first group 310A and a second group 310B of the contact pads 310. The circuit board 300 also includes a third group 330A and a fourth group 330B of contact pads formed on the top side 302 of the circuit board 300. The group 330B of contact pads is positioned on the loop back connector tab 306. On the bottom side 304 shown in FIG. 4C, the circuit board 300 includes contact pads 355 positioned on the main connector tab 308. Among the contact pads 355, the circuit board 300 includes a first group 355A and a second group 355B of the contact pads 355. The circuit board 300 also includes a third group 375A and a fourth group 375B of contact pads formed on the bottom side 304 of the circuit board 300.

The groups 310A, 330A, 355A, and 375A of contact pads are also referred to herein as “bypass contact pads.” Each contact pad among the group 310A is respectively coupled to a contact pad among the group 330A by a conductive metal trace in the circuit board 300. Similarly, each contact pad among the group 355A is respectively coupled to a contact pad among the group 375A by a conductive trace in the circuit board 300. Additionally, the groups 330A and 375A of contact pads are electrically coupled to the signal conductors on the data cables in the rows 400 and 405, for bypass of data signals to and from a backplane PCB. As shown in FIG. 2B, the data cables in the row 400 include signal conductors and drain or ground conductors, which are referenced as the conductors 450. Each of the conductors 450 is individually coupled to a contact pad among the group 330A of contact pads on the top side 302 of the circuit board 300. Similarly, as shown in FIG. 2C, the data cables in the row 405 include signal conductors and drain or ground conductors, which are referenced as the conductors 455. Each of the conductors 455 is individually coupled to a contact pad among a group 375A of contact pads on the bottom side 304 of the circuit board 300.

The terminal rows 510 and 515 of terminal contacts within the connector housing 100 make electrical contact with contact pads formed on the top and bottom sides 302 and 304 of the circuit board 300. The group 510A of terminal conductors (see FIG. 3B) seat upon and make electrical contact with the group 310A of contact pads. More particularly, the tail contacts 511B-514B of the conductors 511-514 in the group 510A are seated upon and make electrical contact with contact pads in the group 310A of contact pads. The group 510B (see FIG. 3B) of terminal conductors seat upon and make electrical contact with the group 310B of contact pads. The tail contacts 531B-534B of the conductors 531-534 in the group 510B are seated upon and make electrical contact with contact pads in the group 310B of contact pads.

Further, the group 515A (see FIG. 3C) of terminal conductors seat upon and make electrical contact with the group 355A of contact pads. More particularly, the tail contacts 551B-554B of the conductors 551-554 in the group 515A are seated against and make electrical contact with contact pads in the group 355A of contact pads. The group 515B (see FIG. 3C) of terminal conductors seat upon and make electrical contact with the group 355B of contact pads. The tail contacts 571B-574B of the conductors 571-574 in the group 515B are seated against and make electrical contact with contact pads in the group 355B of contact pads.

Contact pads in the group 310B of contact pads are electrically coupled to corresponding contact pads in the group 330B of contact pads by conductive metal traces in the circuit board 300. Contact pads in the group 355B of contact pads are electrically coupled to corresponding contact pads in the group 375B of contact pads by conductive metal traces in the circuit board 300.

The groups 330B and 375B of contact pads are positioned on the loop back connector tab 306 in the example shown, although any of the contact pads or groups thereof may be positioned at other locations in some cases. The loop back connector tab 306 and the groups 330B and 375B of contact pads provide a type of PCB-style, card edge connector interface for low-speed data signal loop back communication. As described in further detail below, the connector tab 306 can be inserted into a loop back connector mounted on a backplane PCB.

In the embodiment illustrated, the centerlines of the contact pads in the groups 310A, 310B, 330A, 330B, 355A, 355B, 375A, and 375B are all parallel with one another. That is, the longitudinal or lengthwise centerlines of the contact pads in the groups 310A, 310B, 330A, 330B, 355A, 355B, 375A, and 375B are all parallel with one another. Centerlines of the contact pads in the groups 310A, 310B, 330A, 330B, 355A, 355B, 375A, and 375B are all parallel with corresponding centerlines of the terminal conductors in the groups 510A, 510B, 515A, and 515B of the terminal conductors. For example, the longitudinal or lengthwise centerlines of the contact pads in the groups 310A, 310B, 330A, 330B, 355A, 355B, 375A, 375B are all parallel with the longitudinal or lengthwise centerlines of the terminal conductors in the groups 510A, 510B, 515A, 515B of terminal conductors. Additionally, the centerlines of the contact pads in the groups 310A and 355A are aligned with (e.g., sharing the same centerline with) the corresponding centerlines of the contact pads in the groups 330A and 375A. For example, the longitudinal or lengthwise centerlines of the contact pads in the groups 310A, 355A are aligned with the longitudinal or lengthwise centerlines of the contact pads in the groups 330A, 375A. In other examples, the centerlines of the contact pads in the groups 310A, 355A can be offset or staggered from the centerlines of the contact pads in the groups 330A, 375A.

The signal and drain conductors of the data cables 410, 420, 430, and 440 are coupled to the contact pads in the group 330A of contact pads. The data cables 410, 420, 430, 440 are thus electrically coupled to the group 510A of terminal conductors through the circuit board 300, by way of the conductive metal traces between the groups 310A and 330A of contact pads in the circuit board 300. Additionally, the signal and drain conductors of the data cables 415, 425, 435, and 445 are coupled to the contact pads in the group 375A of contact pads. Thus, the data cables 415, 425, 435, 445 are coupled to the group 515A of terminal conductors through the circuit board 300, by way of the conductive metal traces between the groups 355A and 375A of contact pads in the circuit board 300.

The groups 310A, 330A, 355A, and 375A of contact pads can be used to communicate high-speed differential data signals, sideband signals, power, or other signals through the circuit board 300. The groups 310A, 330A, 355A, and 375A of contact pads can be used together with the groups 510A and 515A of terminal conductors and the data cables 410, 415, 420, 425, 430, 435, 440, and 445 to communicate high-speed differential data signals through the connector 10 for bypass purposes. The groups 310B, 330B, 355B and 375B of contact pads can be used to communicate low-speed differential data signals, sideband signals, power, or other signals through the circuit board 300. The groups 310B, 330B, 355B, and 375B of contact pads can be used together with the groups 510B and 515B of terminal conductors to communicate low-speed differential data signals, sideband signals, or other signals through the connector 10 for loop back purposes. These and other aspects of the connector 10 are described in further detail below with reference to FIG. 6A.

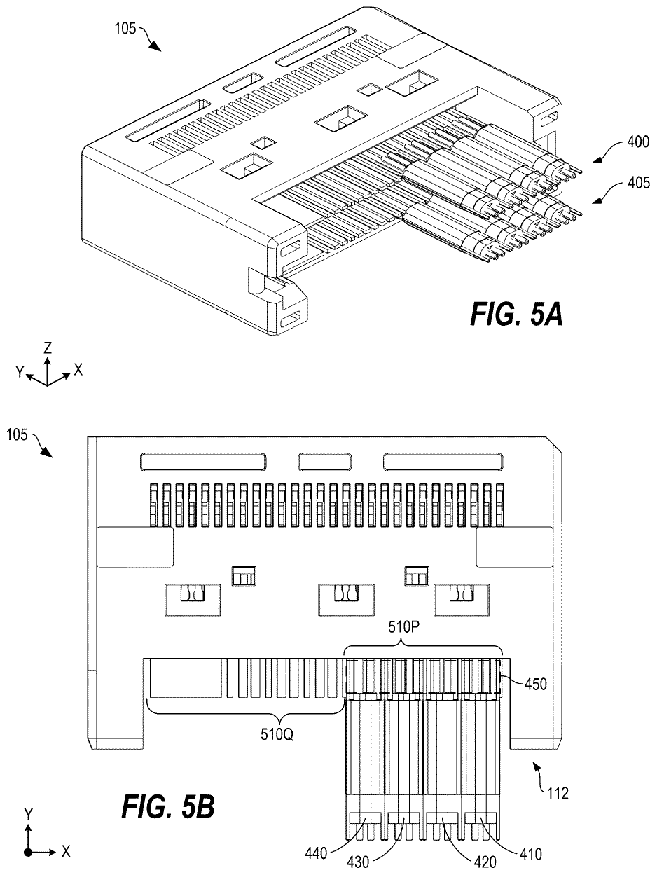

Variations on the connector 10 are within the scope of the embodiments. As one example, rather than the conductors in the rows 400 and 405 of data cables being electrically coupled to the circuit board 300, the conductors can be directly coupled to the terminal conductors in the connector housing, bypassing the circuit board 300 entirely. FIG. 5A illustrates a perspective view of another example connector housing 105 in that context, and FIG. 5B illustrates a top view of the connector housing 105.

The connector housing 105 is similar to the connector housing 100 described above and shown in FIG. 3A. However, the terminal rows within the connector housing 105 have been modified for direct coupling to the conductors in the rows 400 and 405 of data cables. The circuit board 300 is omitted from view in FIGS. 5A and 5B, to better illustrate the direct coupling. The connector housing 105 can be used in place of the connector housing 100 in alternative embodiments of the connector 10 described herein. If the connector housing 105 is used in place of the connector housing 100 in the connector 10, then the groups 310A, 330A, 355A, and 375A (see FIGS. 4B and 4C) of contact pads can also be omitted from the circuit board 300.

The connector housing 105 includes two rows of terminal conductors. Referring to FIG. 5B, one of the rows of terminal conductors is identified in two groups, including groups 510P and 510Q of terminal conductors. The terminal conductors in group 510P have tail ends that are different than those in the connector housing 100. The tail ends of the terminal conductors in group 510P are flat and formed to provide a surface for direct coupling to the conductors of the data cables 410, 420, 430, and 440, as shown in FIGS. 5A and 5B. More particularly, the data cables 410, 420, 430, and 440 include signal conductors and drain or ground conductors, which are referenced as the conductors 450 in FIG. 5B. The conductors 450 are directly coupled to the group 510P of terminal conductors in the connector housing 105. Each of the conductors 450 is individually coupled to a respective terminal conductor among the group 510P of terminal conductors. The conductors 450 can be electrically coupled to the group 510P of terminal conductors using any suitable approach, such as soldering, sintering, welding, conductive adhesives, or other approaches.

The group 510Q of terminal conductors is illustrated in a representative fashion in FIGS. 5A and 5B. The tail ends of the terminal conductors in group 510Q are illustrated as being flat. However, in practice, the tail ends of the terminal conductors in group 510Q can be shaped the same way as the group 510B of terminal conductors shown in FIG. 3B. The terminal conductors in the group 510Q can be designed for contact coupling (e.g., spring-biased, metal-to-metal wipe contact) with contact pads on the circuit board 300.

FIG. 6A illustrates a perspective view of an example loop back connector storage backplane system 60 (also “storage system 60”), an example external device 61, and the connector 10. FIG. 6B illustrates an exploded perspective view of the storage system 60 shown in FIG. 6A with the connector 10 and the external device 61 omitted from view. FIG. 6C illustrates a top view of a storage loop back unit 65A and a backplane circuit board 600 shown in FIG. 6A. FIG. 6D illustrates the top view of the storage loop back unit 65A and the backplane circuit board 600 shown in FIG. 6A with the connector 10 omitted from view. FIG. 6E illustrates a front view of the storage loop back unit 65A of the storage system 60 shown in FIG. 6A. FIG. 6F illustrates the front view of the storage loop back unit 65A of the storage system 60 shown in FIG. 6A with the connector 10 omitted from view. FIG. 6G illustrates the top view of the storage loop back unit 65A of the storage system 60 shown in FIG. 6A with the backplane circuit board 600 of the storage system 60 omitted from view. FIG. 6H illustrates a back view of the storage loop back unit 65A of the storage system 60 shown in FIG. 6A with the backplane circuit board 600 omitted from view.

The storage system 60 can be embodied and implemented as a backplane storage assembly or system. The storage system 60 is illustrated as a representative example and is not drawn to any particular scale or size. The shape, size, proportion, and other characteristics of the storage system 60 can vary as compared to that shown. For example, the backplane circuit board of the storage system 60 can have a different shape or include a different number or arrangement of apertures compared to what is shown in the figures, and other variations are within the scope of the examples described herein. Additionally, one or more of the parts or components of the storage system 60, as illustrated in the drawings and described herein, can be omitted in some cases. The storage system 60 can also include other parts or components that are not illustrated.

Referring among FIGS. 6A to 6H, the storage system 60 includes a backplane circuit board 600 (also “backplane PCB 600”) and one or more storage loop back units coupled to the backplane PCB 600. The storage system 60 is designed to incorporate eight (8) storage loop back units in the example shown. The storage loop back units 65A and 65H are illustrated in FIG. 6A, and the other storage loop back units are omitted from view in FIG. 6A for simplicity. The storage loop back units can be arranged side-by-side and/or stacked over one another on the backplane PCB 600, for relatively higher density and data rate interconnections. The storage system 60 can include any suitable number of storage loop back units among various embodiments.

The storage loop back unit 65A includes a support shroud 700A, a card edge connector 800A, and the connector 10. The support shroud 700A and the card edge connector 800A are mounted to the backplane PCB 600 as described below. The connector 10 is installed (e.g., inserted, positioned, etc.) in the support shroud 700A and mated with the card edge connector 800A. The storage loop back unit 65H also includes a support shroud 700H and a card edge connector 800H mounted to the backplane PCB 600. A connector similar to the connector 10 can also be mated with the support shroud 700H and the card edge connector 800H, although not illustrated in FIG. 6A. The support shrouds and card edge connectors are described in further detail below.

The external device 61 is coupled to the connector 10 through the backplane PCB 600 in the example shown. The external device 61 can be embodied as a memory or data storage device, as one example, among other types of devices. The external device 61 can be embodied as an enterprise and datacenter standard form factor (EDSFF) device having a card edge connector tab interface. The card edge interface can adhere to the SFF-TA-1002 specification, as one example, among other interface specifications. The card edge interface of the external device 61 can be mated and electrically coupled with the connector 10 in the storage system 60. The connector tab interface of the external device 61 extends through a connection aperture of the backplane PCB 600 and is inserted into the front port opening 12 of the connector 10. Contact pads of the connector tab interface on the external device contact the terminal conductors in the terminal rows 510 and 515 inside the connector housing 100 of the connector 10, for data communication between them. Thus, the external device 61 is electrically coupled to the connector 10. The connector 10 is also electrically coupled to the backplane PCB 600 through the loop back connector tab 306 and the card edge connector 800A.

A number of external devices can be interfaced with the storage system 60. An external device similar to the external device 61 can be coupled to each of the storage loop back units. The storage system 60 is designed to facilitate data communication among and between the external device 61 and the other external devices coupled to the storage system 60 through the loop back connections in the storage system 60. The storage system 60 is also designed to facilitate bypass data communication from the external devices to other devices or systems (not shown) apart from the storage system 60. The storage system 60 facilitates bypass data communication through the rows 400 and 405 of data cables, for example, of the connector 10, among other connectors in the storage system 60. The storage system 60 is designed for a 1U rack arrangement in the example shown in FIG. 6A, and the external device 61 is positioned horizontally for that arrangement. The storage system 60 can be extended for use with other types of rack mount arrangements, including 2U and other rack arrangements, in which case the external device 61 and others can be positioned side-by-side, vertically. The connector apertures through the backplane PCB 600 and other features of the storage system 60 can also be rearranged or repositioned to accommodate the 2U rack arrangement.

The backplane PCB 600 can be embodied as a PCB including a number of conductive metal layers and dielectric layers, laminated in an alternating arrangement together. The dielectric layers can be formed from a range of suitable dielectric materials, including polytetrafluorocthylene (PTFE) laminates, ceramic-filled PTFE laminates, glass microfiber reinforced PTFE laminates, other suitable dielectric laminate materials, and combinations thereof. The metal layers can include metal traces, contact pads, and related features, and plated through-hole vias can be relied upon to electrically couple the metal traces, contact pads, and other features together. The backplane PCB 600 can also include a number of exposed contact pads in some cases.

The backplane PCB 600 includes connector apertures that are formed through the backplane PCB 600 from a front side 602 to a back side 604 of the backplane PCB 600. The backplane PCB 600 includes connector apertures 610A, 610B, 610C, 610D, 610E, 610F, 610G, and 610H, as best shown in FIG. 6B. The backplane PCB 600 can include another number of connector apertures 610 in other examples. The backplane PCB 600 also includes mounting apertures formed in or through the backplane PCB 600 around each of the connector apertures 610A, 610B, 610C, 610D, 610E, 610F, 610G, 610H. For example, as shown in FIG. 6E, the backplane PCB 600 includes mounting apertures 621B-626B around the connector aperture 610B.

The backplane PCB 600 also includes mounting aperture sets formed in or through the backplane PCB 600 at locations adjacent to the connector apertures 610A, 610B, 610C, 610D, 610E, 610F, 610G, and 610H. Each of the mounting aperture sets includes two mounting apertures, such as the mounting apertures 631A and 632A adjacent to the connector aperture 610A and the mounting apertures 631B and 632B adjacent to the connector aperture 610B. The housing of a card edge connector is mechanically interfaced with each mounting aperture set in the storage system 60, as described below.

Referring to FIG. 6B, the support shroud of each storage loop back unit includes a support frame. For example, the support shroud 700A includes a support frame 710A, and the support shroud 700H includes a support frame 710H. The support shrouds 700A, 700H, and others in the storage system 60 can be embodied as metal frames that are stamped, bent, and/or otherwise formed from a sheet of metal, although other types of materials can be relied on in some cases. The support shroud 700A is aligned with and mechanically interfaced to the backplane PCB 600 over the connector aperture 610A in the example shown. The support shroud 700A includes mounting pins 721A-726A that mechanically interface with the mounting apertures around the connector aperture 610A.

The support frame 710A includes an internal region 702A of space in which the connector 10 can be positioned and extend through. When the connector 10 is positioned in the support frame 710A, at least a portion of the connector housing 100 and the overmold housing 200 is positioned in the internal region 702A. The front port end 110 of the connector housing 100 extends through the internal region 702A and through the connector aperture 610A formed through the backplane PCB 600.

The support frame 710A can also include one or more guide channels, recesses, locating slots, apertures, stops, or interlock arms to mechanically interface with, guide, position, and/or secure the connector 10 within the support frame 710A. Referring to FIG. 6B, the support frame 710A includes a slot 730A and an interlock arm 740A with a locking stop 742A (see FIGS. 6E and 6F) positioned at one end of the interlock arm 740A. The slot 730A is formed in a first sidewall of the support frame 710A, and the interlock arm 740A is positioned at a second sidewall of the support frame 710A opposite the first sidewall. The support frame 710H also includes a similar slot 730H and an interlock arm 740H with a locking stop 742H. In some examples, the internal region 702A of the support frame 710A can include one or more locating slots that align with one or more locating bumps formed on the connector housing 100 of the connector 10, on the overmold housing 200 of the connector 10, or both.

When the connector 10 is installed, an edge of the circuit board 300 of the connector 10 aligns and interfaces with the slot 730A of the support frame 710A. The slot 730A helps to align the connector tab 306 of the circuit board 300 into the card edge connector 800A, when the connector 10 is positioned in the internal region 702A of the support frame 710A. The slot 730A can also at least partly limit movement of the connector 10 in a direction “Y” relative to the backplane PCB 600 when the connector 10 is positioned within the support frame 710A.

The interlock arm 740A and locking stop 742A are embodied as a spring-based interlock arm in the example shown, although another type of interlock arm or mechanism may be used in other examples to secure the connector 10 in place. The interlock arm 740A and locking stop 742A can secure the connector 10 in place relative to the support frame 710A. For instance, the interlock arm 740A and locking stop 742A can secure portions of the connector housing 100 and the overmold housing 200 of the connector 10 in place within the internal region 702A of the support frame 710A. The interlock arm 740A and locking stop 742A can at least partly limit movement of the connector 10 in the direction “Y” relative to the backplane PCB 600 when the connector 10 is positioned within the support frame 710A.

The card edge connector 800A can be embodied as at least one of a board connector, a card edge connector, or a vertical card edge connector in various examples, and other types of connectors can be used in some cases. As identified among FIGS. 6B, 6D, and 6G, the card edge connector 800A includes a front port opening 812A located at a top port end 810A and a terminal foot 813A located at a base end 811A. The base end 811A includes a base mounting surface 820A and mounting posts 831A and 832A, which extend from the base mounting surface 820A. The mounting posts 831A and 832A mechanically interface with the mounting apertures 631A and 632A (see FIG. 6B) of the backplane PCB 600 to secure the card edge connector 800A over the backplane PCB 600, and other card edge connectors of the storage system 60 are supported in a similar way.

The card edge connector 800A includes wafer assemblies positioned within an internal region 802A (see FIG. 6H) of the card edge connector 800A. The wafer assemblies include terminal rows of terminal conductors. The front ends 920A (see FIG. 6F) of a first terminal row are located at the front port opening 812A and tail ends 930A (see FIG. 6H) are located at the terminal foot 813A of the card edge connector 800A. The front ends 925A of a second terminal row are located at the front port opening 812A and tail ends 935A are located at the terminal foot 813A. The tail ends 930A, 935A of the terminal rows of the card edge connector 800A are electrically coupled to contact pads on the backplane PCB 600 when the card edge connector 800A is installed on the backplane PCB 600.

When the connector housing 100 and the overmold housing 200 of the connector 10 are positioned in the support frame 710A, the connector tab 306 of the connector 10 is positioned in the front port opening 812A of the card edge connector 800A. In that case, the loop back connector tab 306 of the connector 10 is positioned in the front port opening 812A of the card edge connector 800A. The groups 330B and 375B of contact pads on the loop back connector tab 306 make electrical contact with the front ends 920A and 925A of the terminal rows within the card edge connector 800A when the connector 10 is installed in the storage system 60. Thus, the card edge connector 800A permits an electrical coupling between the groups 330B and 375B of contact pads of the connector 10 and the contact pads and metal traces of the backplane PCB 600.

Referring to FIG. 6C, the connector 10 is installed with the external device 61 in the storage system 60. The connector 10 extends through the support shroud 700A on the front side 602 of the backplane PCB 600, through the connector aperture 610A in the backplane PCB 600 (see FIG. 6B), and extends beyond the back side 604 of the backplane PCB 600. The connector tab 306 of the connector 10 is mated with the card edge connector 800A on the front side 602 of the backplane PCB 600 in that configuration. The interlock arm 740A and locking stop 742A of the support frame 710A secure the connector tab 306 in place in the arrangement shown. The interlock arm 740A and locking stop 742A can at least partly limit movement of the connector tab 306 in the direction “Y” relative to the card edge connector 800A when the connector 10 is positioned within the support frame 710A.

The external device 61 is interfaced with the connector 10 in the example shown in FIG. 6C. As noted above, the external device 61 can be embodied as a type of EDSFF device including a PCB-styled card edge connector tab interface with exposed contact pads. The exposed contact pads of the external device 61 contact the terminal conductors in the terminal rows 510 and 515 of the connector 10, when the interface of the external device 61 is inserted into the front port opening 12 (see FIG. 2C) of the connector 10 as shown in FIG. 6C. More particularly, the external device 61 can be embodied as an EDSFF device having a 1C, 2C, 4C, or 4C+ PCB-styled connector tab interface configuration in various examples, and the embodiments can be extended for use with other types of interfaces. Referring to FIG. 6D, the external device 61 includes PCB-styled connector tabs 62A, 62B, and 62C (also “the connector tabs 62”) having groups 63A, 63B, and 63C of contact pads formed on a top side of the connector tabs 62. Although not visible in FIG. 6D, the connector tabs 62 can also include similar contact pads formed on the bottom sides of the connector tabs 62.

When the storage system 60 is assembled, the connector tab 62A of the external device 61 is inserted into the front port opening 12 of the connector 10. When inserted, the terminal conductors in the terminal rows 510 and 515 of the connector 10 will wipe over and contact the contact pads on the connector tab 62A of the external device 61. As shown in FIGS. 6C and 6D, in examples where the connector tab 62A of the external device 61 is positioned within the connector 10, the channel 160 (see FIGS. 1D and 1E) on the connector housing 100 accommodates (e.g., receives, guides, supports, etc.) a side edge portion of the connector tab 62B of the external device 61.

The connector 10 is not sized for (e.g., large or wide enough for) electrical connection with the connector tabs 62B and 62C in the example shown. However, in other examples, the connector 10, the connector aperture 610A through the backplane PCB 600, and the support frame 710A can be larger and facilitate electrical couplings with the connector tabs 62B and 62C of the external device 61.

FIG. 7A illustrates a perspective view of another example loop back connector storage backplane system 70 (also “storage system 70”), the external device 61, and the connector 10. FIG. 7B illustrates an exploded perspective view of the storage system 70 shown in FIG. 7A with the connector 10 and the external device 61 omitted from view. FIG. 7C illustrates a top view of a storage loop back unit 75A and a backplane PCB 650 of the storage system 70 shown in FIG. 7A. FIG. 7D illustrates the top view of the storage loop back unit 75A and the backplane PCB 650 of the storage system 70 shown in FIG. 7A with the connector 10 omitted from view. FIG. 7E illustrates a front view of the storage loop back unit 75A of the storage system 70 shown in FIG. 7A. FIG. 7F illustrates the front view of the storage loop back unit 75A of the storage system 70 shown in FIG. 7A with the connector 10 omitted from view. FIG. 7G illustrates the top view of the storage loop back unit 75A of the storage system 70 shown in FIG. 7A with the backplane PCB 650 of the storage system 70 omitted from view. FIG. 7H illustrates a back view of the storage loop back unit 75A of the storage system 70 shown in FIG. 7A with the backplane PCB 650 omitted from view.

The storage system 70 can be embodied and implemented as a backplane storage assembly or system. The storage system 70 is illustrated as a representative example and is not drawn to any particular scale or size. The shape, size, proportion, and other characteristics of the storage system 70 can vary as compared to that shown. For example, the backplane PCB 650 of the storage system 70 can have a different shape or include a different number or arrangement of apertures compared to what is shown in the figures, and other variations are within the scope of the examples described herein. Additionally, one or more of the parts or components of the storage system 70, as illustrated in the drawings and described herein, can be omitted in some cases. The storage system 70 can also include other parts or components that are not illustrated.

Referring among FIGS. 7A to 7H, the storage system 70 includes a backplane PCB 650 and one or more storage loop back units 75 coupled to the backplane PCB 650. The storage system 70 is designed to incorporate eight (8) storage loop back units in the example shown. The storage loop back units 75A and 75H are identified in FIG. 7A. The storage loop back units can be arranged side-by-side and/or stacked over one another on the backplane PCB 650, for relatively higher density and data rate interconnections. The storage system 70 can include any suitable number of storage loop back units among various embodiments.

As illustrated in FIGS. 7A, 7C, and 7D, the external device 61 can be coupled to the connector 10 in the storage system 70, and similar external devices can be coupled to other connectors in the storage system 70. A number of storage loop back units 75 can be arranged side-by-side and/or stacked over one another on the backplane PCB 650 to allow for relatively higher data rate interconnections using a number of connectors 10 and external devices 61 in some examples.

The backplane PCB 650 can be embodied as a PCB including a number of conductive metal layers and dielectric layers, laminated in an alternating arrangement together. The dielectric layers can be formed from a range of suitable dielectric materials, including polytetrafluoroethylene (PTFE) laminates, ceramic-filled PTFE laminates, glass microfiber reinforced PTFE laminates, other suitable dielectric laminate materials, and combinations thereof. The metal layers can include metal traces, contact pads, and related features, and plated through-hole vias can be relied upon to electrically couple the metal traces, contact pads, and other features together. The backplane PCB 650 can also include a number of exposed contact pads.

The backplane PCB 650 includes connector apertures that are formed through the backplane PCB 650 from a front side 652 to a back side 654 of the backplane PCB 650. The backplane PCB 650 in the example shown includes the connector apertures 610A, 610B, 610C, 610D, 610E, 610F, 610G, 610H, and the backplane PCB 650 can include another number of connector apertures 610 in other examples.

The backplane PCB 650 also includes mounting aperture sets formed in or through the backplane PCB 650. For example, the backplane PCB 650 includes a first mounting aperture set of mounting apertures 671A, 672A, 673A, and 674A for the support shroud 1000A. The backplane PCB 650 also includes a second mounting aperture set of mounting apertures 671B, 672B, 673B, and 674B. Other numbers and positions of mounting apertures can be relied upon in other examples. The mounting apertures 671A and 672A are formed between the connector apertures 610C and 610D, and the mounting apertures 673A and 674A are formed between the connector apertures 610A and 610B in the example depicted. The backplane PCB 650 also includes mounting aperture sets formed in or through the backplane PCB 650 at locations adjacent to the connector apertures. For example, the backplane PCB 650 includes the mounting apertures 631A and 632A adjacent to the connector aperture 610A and the mounting apertures 631B and 632B adjacent to the connector aperture 610B, as identified in FIG. 7B.

The storage system 70 includes one or more support shrouds that are mechanically coupled to the backplane PCB 650. The storage system 70 in the example shown includes support shrouds 1000A and 1000B coupled to the backplane PCB 650. The storage loop back units are supported by the support shrouds 1000A and 1000B. The support shroud 1000A includes support frames 1010A, 1010B, 1010C, and 1010D in the example shown. The support shroud 1000B includes support frames 1010E, 1010F, 1010G, and 1010H.

Each of the storage loop back units in the storage system 70 include the same or similar components, structure, features, attributes, and functional characteristics. The storage loop back unit 75A is described in detail, and the other storage loop back units in the storage system 70 are similar. The support shrouds 1000A and 1000B are also similar to each other.

The support shroud 1000A can be embodied as a die cast frame assembly, a tin-plated zinc die cast frame assembly, a metallic frame assembly, a stainless steel frame assembly, or a sheet metal frame assembly in various examples, and related types of frame assemblies and materials can be relied upon in other cases. The support shroud 1000A is coupled to the backplane PCB 650 when the storage system 70 is assembled, and the support frame 1010A is aligned over the connector aperture 610A in that case. The support shroud 1000A includes mounting posts that align with and are positioned in the corresponding mounting apertures of the backplane PCB 650. The support shroud 1000A includes mounting posts 1021A, 1022A, 1023A, and 1024A for example, which can be positioned in the corresponding mounting apertures 671A, 672A, 673A, and 674A of the backplane PCB 650, to mechanically couple the support shroud 1000A to the backplane PCB 650.

As shown in FIGS. 7G and 7H, the mounting posts 1021A, 1022A, 1023A, and 1024A include mounting spacers 1026A, 1027A, 1028A, and 1029A, respectively. Each of the mounting spacers 1026A, 1027A, 1028A, and 1029A has a thickness “d”. Together, the mounting spacers 1026A, 1027A, 1028A, and 1029A define a gap 1090A between a back surface 1060A of the support shroud 1000A and the front side 602 of the backplane PCB 650. The backplane PCB 650 can include one or more traces, contacts, contact pads, or other elements formed on the front side 602 in some examples (e.g., on a surface of the front side 602). A trace, contact, contact pad, or other element can be formed on the front side 602 such that it is at least partly within or crosses the gap 1090A between the front side 602 and the mounting surface 1060A on the support shroud 1000A in some cases.

Referring back to FIG. 7B, the support frame 1010A includes an internal region 1002A of space in which one or more portions of the connector 10 can be positioned or extend through. When the connector 10 is positioned in the support frame 1010A, the connector housing 100 and the overmold housing 200 can be positioned within the internal region 1002A. The front port end 110 of the connector housing 100 extends through the internal region 1002A and through the connector aperture 610A formed through the backplane PCB 650, as also illustrated in FIG. 7C.

The support frame 1010A can further include one or more guide channels, recesses, locating slots, apertures, stops, or interlock arms to mechanically interface with, guide, position, and secure the connector 10 within the support frame 1010A. Referring to FIG. 7B, the support frame 1010A includes a slot 1030A and a interlock arm 1040A with a locking stop 1042A (see FIG. 7D) positioned at one end of the interlock arm 1040A. Referring to FIG. 7F, the internal region 1002A of the support frame 1010A also includes locating slots that can align with external features of the connector housing 100 or the overmold housing 200 of the connector 10 in some cases. The internal region 1002A of the support frame 1010A includes locating slots 1051A, 1052A, 1053A, and 1054A, as shown in FIG. 7F, that can align with, interface with, guide, position, and/or at least partly support corresponding locating bumps 251, 252, 253, and 254 formed on the overmold housing 200 of the connector 10, as illustrated in FIG. 7E. In a similar way, the internal region 1002B of the support frame 1010B includes locating slots 1051B, 1052B, 1053B, and 1054B, as shown in FIG. 7F.

The slot 1030A can align with, interface with, guide, position, and/or at least partly support the circuit board 300 of the connector 10. For instance, the slot 1030A allows for the connector tab 306 on the circuit board 300 to be positioned in the card edge connector 800A when the connector 10 is positioned in the internal region 1002A of the support frame 1010A. The slot 1030A can also at least partly limit movement of the connector 10 in a direction “Y” relative to the backplane PCB 650 when the connector 10 is positioned within the support frame 1010A.

The interlock arm 1040A and locking stop 1042A are embodied as a spring-based interlock arm in the example shown, although another type of interlock arm or mechanism may be used in other examples to secure the connector 10 in place. The interlock arm 1040A and locking stop 1042A can secure the connector 10 in place relative to the support frame 1010A. For instance, the interlock arm 1040A and locking stop 1042A can secure the connector housing 100 and the overmold housing 200 of the connector 10 in place within the internal region 1002A of the support frame 1010A. The interlock arm 1040A and locking stop 1042A can at least partly limit movement of the connector 10 in a direction “Y” relative to the backplane PCB 650 when the connector 10 is positioned within the support frame 1010A.

The card edge connector 800A is coupled to the backplane PCB 650 at a location adjacent to the support frame 1010A and the connector aperture 610A. The mounting posts 831A, 832A of the card edge connector 800A are positioned in the corresponding mounting apertures 631A and 632A on the backplane PCB 650 in the example shown to couple the card edge connector 800A to the backplane PCB 650. The card edge connector 800A is coupled to the backplane PCB 650 at a location adjacent to the support frame 1010A. Thus, when the connector 10 is positioned in the support frame 1010A, the connector tab 306 of the connector 10 is positioned in the front port opening 812A of the card edge connector 800A and between the terminal rows of the card edge connector 800A.

The interlock arm 1040A and locking stop 1042A on the support frame 1010A can at least partly secure the connector tab 306 in place within the card edge connector 800A. The interlock arm 1040A and locking stop 1042A can at least partly limit movement of the connector tab 306 in a direction “Y” relative to the card edge connector 800A when the connector 10 is positioned within the support frame 1010A. Also, when the connector tab 62A of the external device 61 is positioned within the connector housing 100 of the connector 10 while the connector 10 is positioned within the support frame 1010A, the channel 160 on the connector housing 100 can be used to accommodate (e.g., receive, guide, support) a portion of the connector tab 62B on the external device 61 as shown in FIGS. 7C and 7D.

Terms such as “top,” “bottom,” “side,” “front,” “back,” “right,” and “left” are not intended to provide an absolute frame of reference. Rather, the terms are relative and are intended to identify certain features in relation to each other, as the orientation of structures described herein can vary. The terms “comprising,” “including,” “having,” and the like are synonymous, are used in an open-ended fashion, and do not exclude additional elements, features, acts, operations, and so forth. Also, the term “or” is used in its inclusive sense, and not in its exclusive sense, so that when used, for example, to connect a list of elements, the term “or” means one, some, or all of the elements in the list.

Combinatorial language, such as “at least one of X, Y, and Z” or “at least one of X, Y, or Z,” unless indicated otherwise, is used in general to identify one, a combination of any two, or all three (or more if a larger group is identified) thereof, such as X and only X, Y and only Y, and Z and only Z, the combinations of X and Y, X and Z, and Y and Z, and all of X, Y, and Z. Such combinatorial language is not generally intended to, and unless specified does not, identify or require at least one of X, at least one of Y, and at least one of Z to be included. The terms “about” and “substantially,” unless otherwise defined herein to be associated with a particular range, percentage, or related metric of deviation, account for at least some manufacturing tolerances between a theoretical design and manufactured product or assembly, such as the geometric dimensioning and tolerancing criteria described in the American Society of Mechanical Engineers (ASME®) Y14.5 and the related International Organization for Standardization (ISO®) standards. Such manufacturing tolerances are still contemplated, as one of ordinary skill in the art would appreciate, although “about,” “substantially,” or related terms are not expressly referenced, even in connection with the use of theoretical terms, such as the geometric “perpendicular,” “orthogonal,” “vertex,” “collinear,” “coplanar,” and other terms.

The above-described embodiments of the present disclosure are merely examples of implementations to provide a clear understanding of the principles of the present disclosure. Many variations and modifications can be made to the above-described embodiments without departing substantially from the spirit and principles of the disclosure. In addition, components and features described with respect to one embodiment can be included in another embodiment. All such modifications and variations are intended to be included herein within the scope of this disclosure.

What is claimed is:

1. A connector, comprising:
a connector housing;
a row of terminal conductors positioned within the connector housing; and
a circuit board comprising a main connector tab positioned within the connector housing and a loop back connector tab that extends outside of the connector housing.

2. The connector of claim 1, further comprising:
a data cable with conductors coupled to contact pads on the circuit board and the row of terminal conductors; and
an overmold housing molded over at least a portion of the data cable and over at least a portion of the circuit board.

3. The connector of claim 1, further comprising:
a data cable with conductors directly coupled to terminal conductors among the row of terminal conductors; and
an overmold housing molded over at least a portion of the data cable and over at least a portion of the circuit board.

4. The connector of claim 1, wherein:
the circuit board further comprises a row of terminal contact pads positioned on the main connector tab; and
the row of terminal contact pads comprises a group of loop back contact pads and a group of bypass contact pads.

5. The connector of claim 4, wherein:
a first group of terminal conductors among the row of terminal conductors is coupled to the group of loop back contact pads; and
a second group of terminal conductors among the row of terminal conductors is coupled to the group of bypass contact pads.

6. The connector of claim 1, wherein:
the circuit board further comprises a first group of loop back contact pads on the main connector tab and a second group of loop back contact pads on the loop back connector tab; and
contact pads among the first group of loop back contact pads are electrically coupled to corresponding contact pads among the second group of loop back contact pads by conductive traces of the circuit board.

7. The connector of claim 1, wherein:
the circuit board further comprises a first group of bypass contact pads on the main connector tab and a second group of bypass contact pads; and
contact pads among the first group of bypass contact pads are electrically coupled to corresponding contact pads among the second group of bypass contact pads by conductive traces of the circuit board.

8. The connector of claim 1, wherein the circuit board comprises a row of terminal contact pads positioned on the main connector tab and coupled to the row of terminal conductors in the connector housing, a group of bypass contact pads positioned on the circuit board, and a group of loop back contact pads positioned on the loop back connector tab.

9. The connector of claim 1, wherein:
the main connector tab of the circuit board comprises a group of loop back contact pads;
a first group of terminal conductors among the row of terminal conductors is coupled to the group of loop back contact pads; and
a second group of terminal conductors among the row of terminal conductors is directly coupled to conductors of a bypass data cable.

10. The connector of claim 1, wherein a centerline of the loop back connector tab is offset from and parallel to a centerline of the connector housing.

11. A connector, comprising:
a connector housing comprising a row of terminal conductors;
a circuit board comprising a main connector tab positioned within the connector housing;
a data cable with conductors coupled to the row of terminal conductors; and
an overmold housing molded over at least a portion of the data cable and over at least a portion of the circuit board, wherein the circuit board further comprises a loop back connector tab that extends outside of the overmold housing.

12. The connector of claim 11, wherein the conductors of the data cable are coupled to contact pads on the circuit board and the row of terminal conductors.

13. The connector of claim 11, wherein the conductors of the data cable are directly coupled to terminal conductors among the row of terminal conductors.

14. The connector of claim 11, wherein:
the circuit board further comprises a row of terminal contact pads positioned on the main connector tab; and
the row of terminal contact pads comprises a group of loop back contact pads and a group of bypass contact pads.

15. The connector of claim 14, wherein:
a first group of terminal conductors among the row of terminal conductors is coupled to the group of loop back contact pads; and
a second group of terminal conductors among the row of terminal conductors is coupled to the group of bypass contact pads.

16. A storage system, comprising:
a backplane circuit board comprising a connector aperture formed through the backplane circuit board from a first side to a second side;
a support shroud positioned on the backplane circuit board and over the connector aperture;
a card edge connector coupled to the backplane circuit board at a location adjacent to the support shroud; and
a loop back connector positioned in part within the support shroud and comprising a loop back connector tab mated with the card edge connector.

17. The storage system of claim 16, wherein:
the support shroud comprises a slot formed in a sidewall of the support shroud;
the loop back connector comprises a circuit board; and
the circuit board of the loop back connector extends into the slot of the support shroud when the loop back connector tab is mated with the card edge connector.

18. The storage system of claim 16, wherein the loop back connector further comprises a connector housing that extends through the connector aperture and past the second side of the backplane circuit board when the loop back connector tab is mated with the card edge connector.

19. The storage system of claim 16, wherein the support shroud comprises a spring-based interlock arm that secures the loop back connector in the support shroud.

20. The storage system of claim 16, wherein the loop back connector further comprises:
a connector housing;
a row of terminal conductors positioned within the connector housing; and
a circuit board comprising a main connector tab positioned within the connector housing and the loop back connector tab that extends outside of the connector housing.
